(19) United States
(12) Patent Application Publication
(10) Pub. No.: US 2021/0166182 A1
(43) Pub. Date: Jun. 3, 2021

(54) Processes to Correct for Biases and Inaccuracies

(71) Applicants: The Board of Trustees of the Leland Stanford Junior University, Stanford, CA (US); Université de Bordeaux, Bordeaux (FR)

(72) Inventors: Nicolas Carayol, Beguey (FR); Matthew O. Jackson, Stanford, CA (US)

(73) Assignees: The Board of Trustees of the Leland Stanford Junior University, Stanford, CA (US); Université de Bordeaux, Bordeaux (FR)

(21) Appl. No.: 16/770,562

(22) PCT Filed: Dec. 6, 2018
(86) PCT No.: PCT/US2018/064337

§ 371 Date: Jun. 5, 2020

Related U.S. Application Data
(60) Provisional application No. 62/595,474, filed on Dec. 6, 2017.

(51) Int. Cl. G06Q 10/06; G06Q 30/02; G06Q 30/06; G06F 17/18

(52) U.S. Cl. CPC G06Q 10/06395; G06Q 30/0283; G06F 17/18; G06Q 30/0627; G06Q 30/0282

(57) ABSTRACT

Methods to correct for biases and inaccuracies of subjective data sources are provided. In some instances, data sources provide an indication of quality of an item, and various methods determine an instrinsic quality of the item from the data. In some instances, various methods utilize ratings provided by a collection of raters to determine an intrinsic quality. Biases and inaccuracies of raters can be determined and can be utilized for correction in order to reach an intrinsic quality of an item. A number of applications utilizing quality of an item quality and biases and inaccuracies of raters are also described.

### CROSS-REFERENCE TO RELATED APPLICATIONS

The present invention claims priority to U.S. Provisional Patent Application Ser. No. 62/595,474 entitled “Processes To Evaluate Intrinsic Quality” filed Dec. 6, 2017. The disclosure of U.S. Provisional Patent Application Ser. No. 62/595,474 is herein incorporated by reference in its entirety.

### FIELD OF THE INVENTION

The present invention generally relates to data analytics, including processes for correcting for biases and inaccuracies in data sets, and more specifically relates to determining accuracies and biases of data sources and qualities of items.

### BACKGROUND

Most goods and services that humans consume are evaluated and rated. Prominent examples include (but are not limited to) films, theater, art, books, games, wines, restaurants, bars, clubs, stocks, professional services, transportation services, hotels, universities, teachers, and most consumer products. The internet and various platforms have led to enormous growth in the number of items that are evaluated and the number of people generating online rating information. Selling platforms on the web most often report previous consumers ratings. Numerous other websites collect evaluations from distributed sources and report them to the public. These ratings can come from experts (movie critique ratings) or from users (e.g. Yelp). Importantly, such ratings can provide dramatic increases in market efficiency. In fact, an important innovation that has accompanied the “digital economy” are the ratings that are available about almost everything.

### SUMMARY OF THE INVENTION

Systems and methods are described for correcting biases and inaccuracies in data sets. In an embodiment: A compilation of quality indicators of a set of items is received using a computer system. Each item has been provided a quality indicator by a set of data sources. The set of items is at least two items. The set of data sources is at least two data sources. A first data source and a second data source, of the set of data sources, have each provided a quality indicator of a first item and a second item, of the set of items, an initial estimate of an error and a bias of each data source in the set of data sources is determined using the computer system. An initial estimate of a quality of each item is determined using the computer system. The estimate of the quality of each item, of the set of items are centered, using the computer system, at a current, estimate of the mean quality of all items in the set of items. The estimates of the quality of each item, the error of each data source, and the bias of each data source are solved using the computer systems. Furthermore, the centering of the estimate of the quality of each item at a current estimate of the mean quality of all items and the solving of the estimates of the quality of each item, the error of each data source, and the bias of each data source are iteratively repeated using the computer system, until the estimates converge into a solution that provides a final quality of each item, a final accuracy of each data source, and a final bias of each data source.

In a further embodiment, the quality of each item is solved at each iteration with a formula:

$${Q}_{i}^{t + 1} = \frac{{\sum }_{j} \frac{{1}_{ij} ( {g}_{ij} - {b}_{j}^{t + 1} )}{{( {σ}_{j}^{t + 1} )}^{2}}}{{\sum }_{j} \frac{{1}_{ij}}{{( {σ}_{j}^{t + 1} )}^{2}}} \\ {q}_{i}^{t} = {Q}_{i}^{t} + {\tilde{q}}^{t} - \frac{{\sum }_{{i}^{′}} {Q}_{{i}^{′}}^{t}}{n} )$$

wherein qᵢ^{t} is the quality q of an item i at iteration t, gᵢⱼ is the quality indicator of item i by a data source j, bⱼ^{t} is the bias b of a data source j at iteration t, (σⱼ^{t+1})² is the error σⱼ² of a data source j at iteration t, and Qᵢ^{t} is the overall mean quality in iteration t.

In another embodiment, the error of each data source is solved at each iteration with a formula:

$${( {σ}_{j}^{t + 1} )}^{2} = {\sum }_{i} \frac{{1}_{ij} {( {g}_{ij} - {b}_{j}^{t} - {q}_{i}^{t} )}^{2}}{{n}_{j}}$$

wherein (σ₄^{t+1})² is the error of a data source j at iteration t, gᵢⱼ is the quality indicator of item i by a data source j, qᵢ^{t} is the quality q of an item i at iteration t, bⱼ^{t} is the bias b of a data source j at iteration t, and nⱼ is the total number n of data sources j.

Ina still further embodiment, the bias of each data source is solved at each iteration with a formula:

$${b}_{j}^{t + 1} = {\sum }_{i} \frac{{1}_{ij} ( {g}_{ij} - {q}_{i}^{t} )}{{n}_{j}} , \text{∀} j$$

wherein bⱼ^{t} is the bias b of a data source j at iteration t, gᵢⱼ is the quality indicator of item i by a data source j, qᵢ^{t} is the quality q of an item i at iteration t, and nⱼ is the total number n of data sources j.

In still another embodiment, the estimates of each itemâs quality are centered at a current estimate of the mean quality of all items with an equation:

$${\tilde{q}}^{t} = {\sum }_{i} \frac{1}{n} ( \frac{{\sum }_{j} \frac{{1}_{ij} {g}_{ij}}{{( {σ}_{j}^{t} )}^{2}}}{{\sum }_{j} \frac{{1}_{ij}}{{( {σ}_{j}^{t} )}^{2}}} )$$

wherein gᵢⱼ is the quality indicator of item i by a data source j, n is the total number of items i, nⱼ is the total number of data sources j, mᵢ is the number quality indicators for each item i, and \tilde{q}ₜ is the best current estimate of the overall average true quality through iteration.

In a yet further embodiment, the initial estimate of each data sourceâs error is an arbitrary positive number.

In yet another embodiment, the initial estimate of each data source's bias bⱼ⁰ is calculated using a formula:

$${b}_{j}^{0} = {\sum }_{i} \frac{{1}_{ij}}{{n}_{j}} ( {g}_{ij} - {\sum }_{k \neq j} \frac{{1}_{ik} {g}_{ik}}{{m}_{i} - 1} ) , \text{∀} j$$

wherein gᵢⱼ is the quality indicator of item i by a data source j, n is the total number of items i, nⱼ is the total number of data sources j, and mᵢ is the number quality indicators for each item i.

In a further embodiment again, the initial estimate of each item's quality qᵢ⁰ is calculated using formulas:

$${Q}_{i}^{0} = \frac{{\sum }_{j} \frac{{1}_{ij} ( {g}_{ij} - {b}_{j}^{0} )}{{( {σ}_{j}^{0} )}^{2}}}{{\sum }_{j} \frac{{1}_{ij}}{{( {σ}_{j}^{0} )}^{2}}} \\ and \\ {q}_{i}^{0} = {Q}_{i}^{0} + {\tilde{q}}^{0} - \frac{{\sum }_{{i}^{′}} {Q}_{{i}^{′}}^{0}}{n} )$$

wherein gᵢⱼ is the quality indicator of item i by a data source j, n is the total number of items i, nⱼ is the total number of data sources j, mᵢ is the number quality indicators for each item i, and Qᵢ⁰ is the overall mean quality in iteration t.

In another embodiment again, the first item is priced based upon the final quality of the first item.

In a further additional embodiment, the first and the second items are displayed in an order based upon the final qualities of the first and the second items.

In another additional embodiment, the first and the second items are displayed on an online marketplace.

In a still yet further embodiment, the first item is displayed when the final quality of the first item exceeds a threshold.

In still yet another embodiment, the first item is displayed on an online marketplace.

In still yet another embodiment, the first item is imported when the final quality of the first item exceeds a threshold.

In still yet another embodiment, a regulatory standard is set based at least upon the final quality of the first item.

In still yet another embodiment, the first item is a consumer product.

In still yet another embodiment, the consumer product is an electronic, grocery, clothing, or vehicle.

In still yet another embodiment, the consumer product is wine.

In still yet another embodiment, the first item is a professional service.

In still yet another embodiment, the professional service is a medical service, a contractor service, a legal service, or a brokerage service.

In still yet another embodiment, the first item is an entertainment program.

In still yet another embodiment, the entertainment program is cinema, theater, television, online streaming, music, or literature.

In still yet another embodiment, the first item is an investment security.

In still yet another embodiment, the first item is a food and beverage establishment.

In still yet another embodiment, the food and beverage establishment is a restaurant, a bar, a club, a winery, a brewery, or a catering establishment.

In still yet another embodiment, the first item is an educational service.

In still yet another embodiment, the educational service is a university, a college, a teacher, or a test preparation course.

In still yet another embodiment, the first item is a transportation and travel service.

In still yet another embodiment, the educational service is a hotel, an airline, a train, a rental car service, or a ridesharing service.

In still yet another embodiment, the first item is a game.

In still yet another embodiment, the first item is a sport team.

In still yet another embodiment, a fraudulent quality indicator within the compilation of quality indicators is identified using the computer system that utilizes a distribution of quality indicators of at least one data source of the set of data sources. The fraudulent quality indicator is removed, using the computer system, from the compilation of quality indicators prior to solving the final quality of each item in the set of items, the final accuracy of each data source of the set of data sources, and the final bias of each data source of the set of data sources.

In still yet another embodiment, the data source is a rater and the quality indicator is a rating.

### BRIEF DESCRIPTION OF THE DRAWINGS

FIG. 1 is a flow chart illustrating a process to utilize a determined intrinsic quality in accordance with an embodiment of the invention.

FIG. 2 is a flow chart illustrating a process to normalize scaled ratings in accordance with an embodiment of the invention.

FIG. 3 is a flow chart illustrating a process to determine a true intrinsic quality of an item in accordance with an embodiment of the invention.

FIG. 4 is a conceptual diagram of a computer system configured to determine a true intrinsic quality of an item in accordance with various embodiments of the invention.

FIG. 5 provides charts of note and wine distribution across vintage years, utilized in accordance with various embodiments of the invention.

FIG. 6 provides charts of kernel notes density plots of a number of wine expert raters, utilized in accordance with various embodiments of the invention.

FIG. 7 provides charts of normalized ratings distributions of two wine expert raters, generated and utilized in accordance with various embodiments of the invention.

FIG. 8 provides charts of convergence of estimated quality of items, generated in accordance with various embodiments of the invention.

FIG. 9 provides charts of convergence of estimated expert biases and inaccuracies, generated in accordance with various embodiments of the invention.

FIG. 10A provides charts of normalized expert biases with estimated quality, generated in accordance with various embodiments of the invention.

FIG. 10B provides charts of normalized expert accuracies and correlation coefficients of expert rates with estimated quality, generated in accordance with various embodiments of the invention.

FIG. 11 provides a chart of the correlation of expert accuracies with predicted expert accuracies, generated in accordance with various embodiments of the invention.

FIG. 12 provides charts of estimated qualities of wine, generated in accordance with various embodiments of the invention.

FIG. 13 provides a chart of rescaling estimated quality onto a scale utilized by an expert wine rater, utilized in accordance with various embodiments of the invention.

FIG. 14 provides charts of distribution wine prices in three markets, utilized in accordance with various embodiments of the invention.

FIG. 15 provides a chart showing the correlation of expert wine rater accuracy with rater rating/price correlation, utilized in accordance with various embodiments of the invention.

FIGS. 16A and 16B provide charts of normalized expert accuracies and biases with estimated quality for the left and right banks, generated in accordance with various embodiments of the invention.

FIGS. 17 and 18 provide charts of difference of expert accuracies and biases with estimated quality, accounting for the left and right banks, generated in accordance with various embodiments of the invention.

### DETAILED DESCRIPTION

Turning now to the drawings and data, a number of embodiments of processes to correct for biases and inaccuracies of subjective data sources are provided. Signal processing techniques that involve evaluating and estimating intrinsic qualities of ratable items and accuracies and biases of raters of these items in accordance with various embodiments of the invention are illustrated. In several embodiments, processes encompass computational and statistical evaluation of ratings. In contrast to commonly practiced methods to evaluate ratings that utilize simple aggregation techniques, which necessarily include rater biases and inaccuracies, many embodiments of the invention use processes to discover biases and inaccuracies and correct for them to achieve a compilation of ratings that reach intrinsic qualities of the rated items. Once estimates of true intrinsic qualities of items are revealed, in accordance with several embodiments, intrinsic qualities can be used in further downstream applications, including (but not limited to) price valuation, product placement, product import and export, regulatory violations, and marketing. And in some embodiments, rater biases and inaccuracies are utilized to discover fake raters and/or fake ratings that are incongruent with a rater's history.

There are many challenges with production of ratings as individual raters may have significant biases and may vary widely in their accuracy in evaluating the quality of a product. Simply averaging ratings can provide biased results, especially for items that have fewer ratings. For example, if some people only rate items that they have extreme experiences with, they may consistently err in terms of making excessively extreme ratings. Also, ratings of people who are very careful and discerning are mixed in with others who are careless and frivolous. To make the most of such rating information, in accordance with a number of embodiments, systems for processing such ratings take into account reviewers' histories of past ratings to evaluate their biases and accuracies. By undoing biases and putting more weight on the most accurate reviewers, well-processed ratings can result in significant improvements in the quality of an aggregate rating.

In accordance with a number of embodiments, systems for processing ratings simultaneously estimate intrinsic qualities of ratable items, the accuracies of raters, and biases of each particular rater. In several embodiments, estimations of qualities, accuracies, and biases are performed on an iterative basis until converged. Convergence of estimates, in accordance with many embodiments, reveals a true intrinsic quality of an item. In numerous embodiments, intrinsic quality is used to evaluate an item's monetary value. In some embodiments, an item's monetary value is determined before the item enters a commercial market. And in various embodiments, true intrinsic qualities determined by processes described herein are better predictors of item prices than average rater scores.

Many embodiments are also directed to revealing rater accuracy and bias. Accordingly, embodiments are directed to evaluating raters on their accuracies and/or biases. In several embodiments, processes are used that provide some immunity to manipulation of ratings and/or selection biases. In some embodiments, the processes correct the accuracy of raters to converge on an intrinsic quality of an item. In a number of embodiments, the processes work around biases of raters such that, their biases are at, least partially mitigated, if not fully eliminated in determined intrinsic qualities.

Various embodiments are directed to revealing when a rater provides a fraudulent rating. Utilizing a ratings and reviews, anomalous and/or outlying ratings are detected in accordance with several embodiments. A number of embodiments detect when an item and/or a rater has a pattern indicative of fraudulent reviews (e.g., when high reviews are bribed). In some embodiments, reviews deemed fraudulent are flagged and/or removed from item quality analysis.

In a number of embodiments, scales of the various raters are adjusted to normalize the ratings of items. For example, one rater may use a scale of 1 to 20 and another rater may use a scale of 1 to 100. According to a number of embodiments, the ratings are normalized to each other so that each rating is on a common and commensurable scale. In many embodiments, normalized ratings are used in a number of processes to estimate intrinsic qualities of ratable items.

In various embodiments, the intrinsic quality of a ratable item is determined. In some embodiments, a ratable item is any item that is rated by a group of individuals. Ratable items, in accordance with several embodiments, include (but are not limited to) consumer products, professional services, food and beverage establishments, entertainment programs, games, sport teams, educational services, transportation and travel services and investment securities.

In a number embodiments, a consumer product is an item available for purchase by a consumer. Consumer products may include (but are not limited to) electronics, groceries, clothing, vehicles, and other retail. In various embodiments, a professional service is an action performed by an individual for another individual, typically for a fee. Professional services may include (but are not limited to) medical services (e.g., doctors), contractor services, legal services (e.g., attorneys), and brokerage services. In some embodiments, a food and beverage establishment is one that provides a food and/or beverage service, often including table and/or bar service. Food and beverage establishment may include (but are not limited to) restaurants, bars, clubs, wineries, breweries, and catering. Likewise, in numerous embodiments, an entertainment program is a product for consumer enjoyment. Entertainment programs may include (but are not limited to) cinema, theater, television, online streaming, music, literature. In several embodiments, educational services are services meant to provide a learning experience. Educational services may include (but are not limited to) universities, colleges, teachers, and test preparation courses. Transportation and travel services are services that provide means to travel. Transportation and travel services may include (but are not limited to) hotels, airlines, trains, rental cars, and ridesharing.

Numerous exemplary embodiments described herein incorporate various processes described herein to determine the intrinsic qualities of wines. In many exemplary embodiments, ratings from experts in the field of wine tasting are utilized to determine a true intrinsic quality of various wines and vintages. In the wine industry it is common for experts to taste and rate wine before it is bottled resulting in ratings known in the industry as an “en primeur” rating. Accordingly, in various exemplary embodiments, “en primeur” ratings are incorporated into processes described within to obtain an intrinsic quality of a wine before it is bottled. In a number of exemplary embodiments, an intrinsic quality of a wine is determined before the wine enters into consumer markets. In several exemplary embodiments, an intrinsic quality of a wine as determined by processes described within is used to determine a future market value of the wine. It should be noted that, although applications to wine industry are described, the various embodiments as detailed within can be implemented in a number of applications, including (but not limited to) applications to films, t heater, art, books, restaurants, investment securities, and most consumer products.

### Definitions and Notation

In order to easily understand the various embodiments described within, the following notations are used. It should be understood, however, that these notations are merely provided to help guide a reader's comprehension of the various described embodiments and processes. These notations are not meant to be limiting in any way. For example, a set of items is denoted as N, however any notation could be used to describe a set of items.

A set N of items i=1, . . . , n is to be rated.

A set M of raters j=1, . . . , m each rate a specific subset of the items Mⱼ⊂M.

The ratings are listed in the n×m matrix g with the gᵢⱼ∈ [symbol] being j's rating of item i, and with gᵢⱼ=. (missing information) indicating that j did not rate item i.

Let 1ᵢⱼ be the indicator variable that is 1 if rater j rated item i, and 0 otherwise (so it is the indicator that gᵢⱼ≠.).

Let mᵢ=Σⱼ1ᵢⱼ be the number of the number of ratings of item i and nⱼ=Σᵢ1ᵢⱼ the number of ratings by expert j.

### Overview of Bias and Error Correction Processes

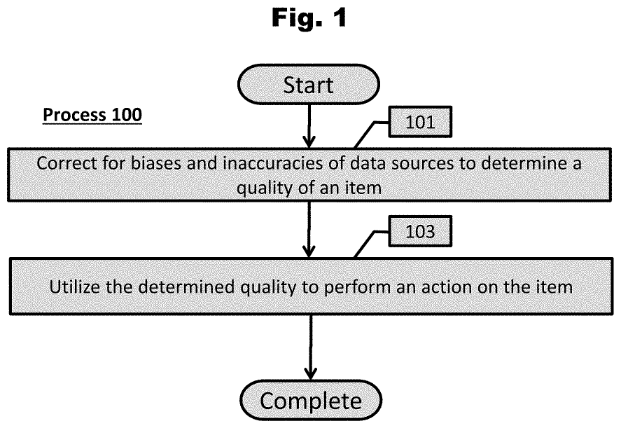

Provided in FIG. 1 is an overview process of correcting for biases and inaccuracies to determine a quality of an item and then utilizing the determined quality to perform an application. Accordingly, the process begins with correcting (101) for biases and inaccuracies to determine a quality of an item. In numerous embodiments, the item is a ratable item and the data sources are raters that rate the item. In various embodiments, an intrinsic quality is determined, which is a quality as determined by collection of individual data sources, correcting for each data source's bias and inaccuracy. Accordingly, a true intrinsic quality should be free of inaccuracies and subjective biases.

As described herein, various embodiments utilize a matrix of data sources and items with enough overlap such that biases and inaccuracies of data sources are determined. In several embodiments, at least two data sources, each providing an indicator of quality for at least two items, is necessary to determine an intrinsic quality of each of the two items. It should be understood, however, that more data sources, each providing quality indicators for multiple items such that a history of each data source can be established to inform of biases and inaccuracies, will produce a more accurate intrinsic quality. In some embodiments, iterative computations of each item's quality and each data source's accuracy and bias are solved until a convergence is reached. Accordingly, various embodiments incorporate Bayesian updating, minimizing some moment function, minimizing the squared errors, or a combination of thereof. In some embodiments, a Generalized Method of Moments is used to solve an items final quality, and the final biases and inaccuracies of each data source.

Once a quality of an item is determined, in accordance with various embodiments, the quality is utilized (103) to perform an action on the item. In some embodiments, a quality is used for price valuation, product placement, product import and export, regulatory violations, and marketing.

In a number of embodiments, an item's quality is used to set a price valuation. For example, in some embodiments, as the higher the quality of an item, the higher the item is valued and priced. In several embodiments, an item's quality is utilized to place a product. For example, various embodiments will sort a product on an online marketplace (e.g., Amazon.com) such that items are displayed in order of their quality. In various embodiments, only items having a quality equal to and/or above a particular quality threshold are displayed. Likewise, various embodiments utilize quality to determine whether an item is imported/exported when the item has a quality equal to and/or above a particular quality threshold. And in several embodiments, a quality of an item is used to set regulatory standards. Further, embodiments utilize quality to set up appropriate products or services prices or to decide to commercialize them or not. Various embodiments compare a set of products' quality to define appropriate products or services prices in a sales period.

In several embodiments, the biases and accuracies of data sources are used to inform about each data source. The estimated error (inverse accuracy) of data sources, calculated as the average squared difference between the estimated item quality and the quality indicator provided by the data source (corrected fir bias), is used in some embodiments to appreciate the data source's reliability. Some embodiments calculate the accuracy of data source for specific types of products to determine on which submarket the data source's knowledge is more dense. When the data sources are raters, various embodiments compare a rater's reliability to prioritize the rater's ratings or the comments the rater provides, or to target the rater in a commercial or incentivizing policy.

Various embodiments are directed to determining whether a rating is fraudulent. There are many instances in which raters have been reported to be paid or bribed to provide a certain rating, from rating games to providing online reviews of restaurants. In some cases, a product might even create a fake reviewer just to review its product. More generally, this involves bribing well-established and visible reviewers to deliberately give a product a high rating.

There are a few cases in which techniques described herein can identify whether there are fraudulent reviews. In some embodiments, fraud can be detected when many raters rate a particular item, and a nontrivial fraction but not all of them are bribed. This scenario results in a pattern in which the distribution of ratings does not follow the usual random pattern around the raters' biased points obtained, but instead has an extra mode at a high level with a statistically rare and identifiable number of ratings that deviate from their mean. In more embodiments, fraud can be detected when a given reviewer is bribed on a non-trivial fraction of items. In this scenario, a rater has an abnormally high number of ratings that are outliers, as detected utilizing the rater's bias and accuracy and the true quality of the items obtained. Accordingly, in a number of embodiments, when a statistically rare and identifiable n umber of ratings that are outliers, these ratings a reflagged an d/or removed from quality analysis for being fraudulent.

### Rating Acquisition and Processing

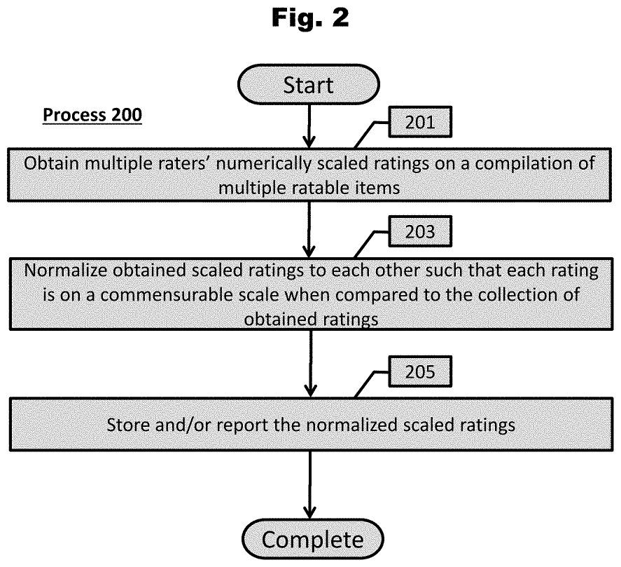

A conceptual illustration of a process to normalize numerically scaled ratings utilizing computer systems in accordance with an embodiment of the invention is provided in FIG. 2. In a number of embodiments, multiple ratings of multiple ratable items are obtained (201) and compiled. An item, in accordance with several embodiments, is any item rated by a group of raters. In many embodiments, items include (but are not limited to) consumer products, professional services, restaurants, entertainment programs (e.g., movies, theater, music, books), and investment securities.

A rater, in accordance with a number of embodiments, is any individual that provides a numerical rating, ranking, or a narrative review on an item. In more embodiments, a rater provides a qualitative narrative review that may be converted into a quantitative numerical rating. Accordingly, in some embodiments, raters are consumers that provide feedback on items previously purchased or used. In more embodiments, raters are experts in an industry that rate, rank, and/or review various items professionally.

In more embodiments, a rater j independently estimates an item's i true quality qᵢ. In some embodiments, rater j may have systematic bias bⱼ, consistently over or under rating the true quality. In further embodiments, raters introduce error εᵢⱼ into their ratings of items. In even more embodiments, ratings consider an item's true quality, systemic bias, and error. In some embodiments, a rater's observed rating is defined by the equation:

gᵢⱼ=qᵢ+bⱼ+εᵢⱼ, (1)

where εᵢⱼ˜Φ(0,σⱼ²) is for the same j, and independent across j, and uncorrelated with the qᵢ. More embodiments are also directed to defining a rater's accuracy as the inversed square of her error:

$${a}_{j} ≡ \frac{1}{{σ}_{j}^{2}} .$$

Rata items to be assessed, in accordance with some embodiments, is defined within a category. In several embodiments, a compilation of rating category is defined by the item to be assessed (e.g., movies). In many embodiments, a category is defined by the raters (e.g., Yelp users). It should be noted, however, some processes do not necessitate a categorical definition of the compilation. In various embodiments, categorical definitions are beneficial to associate a group of items and or raters for comparison.

In numerous embodiments, obtained ratings are numerically scaled. In several embodiments, numerical rankings are obtained and utilized as ratings. In many embodiments, narrative reviews are obtained and converted into scaled numerical ratings. Accordingly, in various embodiments, a quantitative rating value reflects raters'qualitative o pinion of an item. The scale of the rating, in accordance with many more embodiments, is any numerical scale, so long that numerical values correspond with quality of items as determined by a rater. In some embodiments, ratings are scaled from zero to a hundred. In a number of embodiments, ratings are scaled from zero to twenty. In numerous embodiments, ratings are scaled from one to five. In several embodiments, a higher numerical score corresponds with a higher quality. In a multitude of embodiments, lower numerical scores correspond with a higher quality (e.g., ratings based on rankings of items).

Obtained ratings are normalized (203), in accordance with various embodiments, such that each rating is on a commensurable scale when compared to the collection of rankings. Often, ratings can be collected having different scales and/or different distributions. For example, two raters may each use a zero to one hundred scale, but one rater may typically only rate items between seventy and one hundred with an average of ninety and the other rater may typically rate items fifty to a hundred with an average of eighty. Despite having the same theoretical scale, the differences of distribution result in different scales between the two raters, and thus should be normalized to a commensurable scale. Accordingly, a number of embodiments are directed to aligning some order statistics of the distributions and translating them to a common scale.

In accordance with several embodiments, obtained ratings are resealed to a scale defined by a user, and may be dependent on the application. In m any embodiments, a user defined scale of the collection of ratings does not matter, as long a s each rating of the collection of ratings are rescaled to the same commensurable scale and distribution. In some embodiments, each obtained rating is rescaled to a scale of zero to one hundred. In a number embodiments, each obtained rating's scored average is reset to fifty when a scale of zero to one hundred is used. In numerous embodiments, each obtained rating is linearized.

Many embodiments are also directed to trimming each set of ratings of a rater. In certain cases, tails of a rater's compilation of ratings may be noisy and or long. Accordingly, in various embodiments, a certain amount of each rater's compilation of rating is removed from further analysis. In some embodiments, the removed ratings are a certain amount of at least one tail. In many embodiments, a certain amount of the lower tail of each rater's compilation of ratings is removed. In particular embodiments, the lowest five percent of each rater's compilation of ratings is removed.

In a number of embodiments, raw ratings of each rater are rescaled using the equation:

gᵢⱼ=S×(Gᵢⱼ−Gⱼ^{t}^{ₗ})/(Gⱼ^{p}^{ᵤ}−Gⱼ^{p}^{ₗ}) (2)

where G denotes the raw score as described by the rater, S defines the linear scale, pₗ denotes the lower bound of ratings utilized, and pᵤ defines the upper bound of ratings used.

In accordance with several embodiments, normalized scaled ratings are stored and/or reported (205). In further embodiments, normalized scaled ratings may be used in many further downstream applications, including (but not limited to) further statistical analysis on the ratings.

While a specific example of a process for normalizing a collection of scaled ratings is described above, one of ordinary skill in the art can appreciate that various steps of the process can be performed in different orders and that certain steps may be optional according to some embodiments of the invention. As such, it should be clear that the various steps of the process could be used as appropriate to the requirements of specific applications. Furthermore, any of a variety of processes for normalizing a collection of scaled ratings appropriate to the requirements of a given application can be utilized in accordance with various embodiments of the invention.

### Intrinsic Quality of an Item

In accordance with numerous embodiments of the invention, intrinsic qualities of items are determined utilizing ratings. Furthermore, in accordance with several embodiments, raters have errors and biases that can be revealed. Errors and biases of raters, in many embodiments, are compensated for in order to determine a true intrinsic quality of items. In numerous embodiments, qualities of items and errors and biases of raters are calculated using computer systems. In a multitude of embodiments, computer systems perform iterative computations to solve an estimate of each item's quality and each rater's accuracy and bias until a convergence is reached. In some embodiments, computations that are performed result in a determined true intrinsic quality of each item and an accuracy and bias of each reviewer.

In various embodiments, a quality of each item is estimated. In several embodiments, when rater error and bias is known, a quality of each item is estimated by Bayesian updating, minimizing some moment function, minimizing the squared errors, or a combination of thereof. In certain embodiments, error σⱼ² and bias bⱼ are utilized to estimate a true quality of an item using the equation:

$${{min}_{{q}_{i}} {\sum }_{j} \frac{{1}_{ij} ( {g}_{ij} - {b}_{j} - {q}_{i} )}{{σ}_{j}} )}^{2} . \qquad ( 3 )$$

Solving this equation, in accordance with many embodiments, results in an estimate of a quality of an item i:

$${\hat{q}}_{i} = \frac{{\sum }_{j} \frac{{1}_{ij} ( {g}_{ij} - {\hat{b}}_{j} )}{{σ}_{j}^{2}}}{{\sum }_{j} \frac{{1}_{ij}}{{σ}_{j}^{2}}} . \qquad ( 4 )$$

In particular embodiments, an estimate of the unobserved quality of each item is a sum of the relative ratings given by the experts who rated i weighted by each expert's relative accuracy.

In many applications, raters' accuracies

$$\frac{1}{{( {σ}_{j} )}^{2}}$$

and their biases bⱼ are unobserved. Accordingly, numerous embodiments are directed to solving an item's true quality when the accuracy and bias of raters are unknown. In some embodiments, multiple ratings of each expert on multiple items are utilized to simultaneously estimate the bias and accuracy of each expert as well as the true qualities of the items.

In several embodiments, an error (inverse accuracy) of a rater is estimated. In numerous embodiments, an error of a rater is estimated using the equation:

$${\hat{σ}}_{j}^{2} = {\sum }_{i} {1}_{ij} \frac{{( {g}_{ij} - {\hat{b}}_{j} - {\hat{q}}_{i} )}^{2}}{{n}_{j}} , \text{∀} j ; \qquad ( 5 )$$

In a number embodiments, a bias of a rater can be estimated. In numerous embodiments, a bias of a rater is estimated using the equation:

$${\hat{b}}_{j} = {\sum }_{i} {1}_{ij} \frac{( {g}_{ij} - {\hat{q}}_{i} )}{{n}_{j}} , \text{∀} j ; \qquad ( 6 )$$

Note that. (4)-(6) form a system of n+2m equations in the same number of unknowns. This system, however, is still under-identified. Accordingly, in several embodiments, the scale on which items' true qualities lie is normalized. In particular embodiments, items' qualities are normalized to have an average of \tilde{q}>0:

$$\frac{{\sum }_{i} {\hat{q}}_{i}}{n} = \tilde{q} . \qquad ( 7 )$$

In many embodiments, \tilde{q} is chosen by a user. In numerous embodiments, \tilde{q} is selected arbitrarily, as it merely provides an average level from which to interpret qualities and has no effect on estimated accuracies.

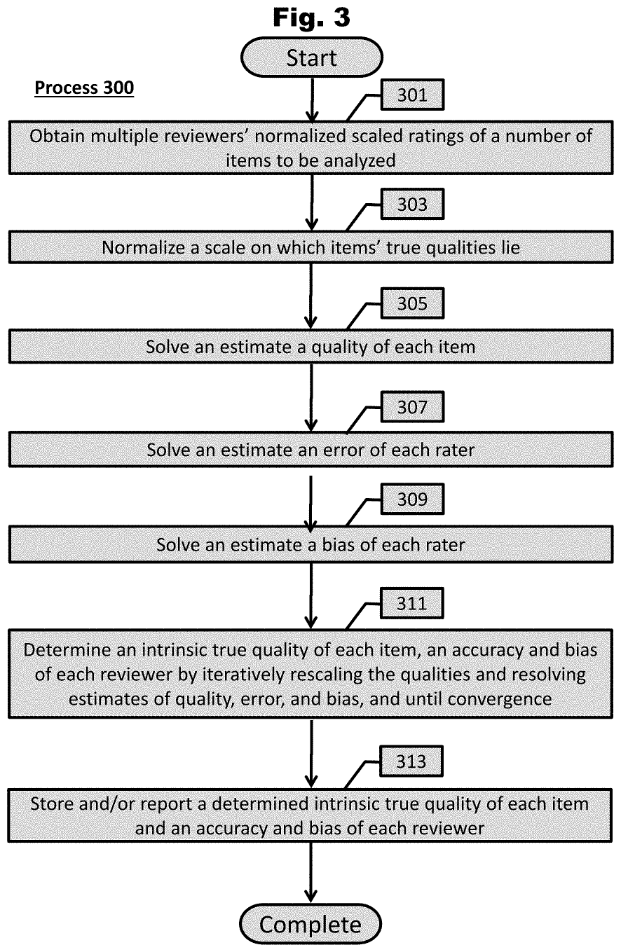

Provided in FIG. 3 is a conceptual illustration of a process to determine a true intrinsic quality of each item and an accuracy and bias of each reviewer utilizing computer systems in accordance with an embodiment of the invention. Accordingly, in the provided embodiment, iterative computations of each item's quality and each rater's accuracy and bias are solved until a convergence is reached, resulting in a determined true intrinsic quality of each item and an accuracy and bias of each reviewer.

In a number of embodiments, multiple raters' normalized scaled ratings of a number of items to be analyzed are obtained (301). An item, in accordance with several embodiments, is any item rated by a group of raters. In many embodiments, items include (but are not limited to) consumer products, professional services, restaurants, entertainment programs (e.g., movies, theater, music, books), and investment securities.

The ratable items to be assessed, in accordance with some embodiments, are defined within a category. In various embodiments, a category is defined by the item to be assessed (e.g., movies). In many embodiments, a category is defined by the raters (e.g., Yelp users). It should be noted, however, some processes do not necessitate a categorical definition of a compilation or ratings. In several embodiments, categorical definitions are beneficial to associate a group of items and or raters for comparison.

In many embodiments, obtained ratings have been normalized such that each rating is on a commensurable scale when compared to the collection of rankings. Any method to normalize the ratings may be used, however, each rating within the collection of ratings should have the same scale, enabling downstream statistical comparison between the ratings. In further embodiments, a collection of obtained ratings is to include at least some overlap between raters and items to be analyzed. Accordingly, various embodiments require that at least two raters of the group of raters each rate at least two items; and that at least two items of the group of items are each rated by at least two raters. In a several embodiments, increased numbers of raters that each rate overlapping groups of items yield a better intrinsic true quality of each rated item.

Several embodiments are directed to determining an intrinsic true quality of each item, and an error and bias of each reviewer by solving estimations of true quality, error, and bias of each reviewer (See process 300). Because the equations (5)-(7), define a corresponding moment condition that holds with equality at the true parameters

$${( {( {q}_{i} )}_{i} , {( {b}_{j} )}_{j} , {( {σ}^{2} )}_{j} )}_{j} ,$$

the system of equations can be solved utilizing Generalized Method of Moments, in accordance with many embodiments.

Given that each equation is continuous and nonzero in a neighborhood of the true parameters, standard results show that the solution provides consistent estimators of the true qualities, biases, and accuracies. To ensure compactness, in accordance with various embodiments, qualities, biases, and errors, are restricted to lie in some compact interval of the reals.

For errors, a lower bound that is positive is imposed, in accordance with numerous embodiments, ruling out infinite variance on the part of any expert. In many embodiments, the finite upper bound on accuracy rules out any expert having a null variance (infinite accuracy) and thus always having a rating that is exactly equal to quality. Accordingly, this requires that t(n)→∞, such that nⱼ≥t(n) and mᵢ≥t(n) grow for all i, j, so that the number of observed ratings for each item grows (so that item qualities are estimable), and the number of items rated by each expert grows (so that experts' errors are estimable). There is no requirement on the relative size of in to n, however, various embodiments do require that various ratings grow fast enough. There are some applications in which there are many more raters than items (e.g., online restaurant reviews), and others in which there are more items than raters (e.g., wines rated by experts), all of which can be examined in accordance with a number of embodiments of the invention.

There are many ways to estimate solutions under GMM, such as parameter grid searches and Markov chain Monte Carlo (MCMC) techniques, which can be used in accordance with a number of embodiments. In some embodiments, a direct technique is utilized, leading to equality by iterating on the system of equations. Accordingly, in a number of embodiments, initial estimates of each rater's error σⱼ² and bias bⱼ⁰ and each item's qualities are determined (303). In a number of embodiments, each rater's error σⱼ² is initiated at some arbitrary positive levels (e.g., all equal to 1). In various embodiments, a rater's bias bⱼ⁰ is initiated by the equation:

$${b}_{j}^{0} = {\sum }_{i} \frac{{1}_{ij}}{{n}_{j}} ( {g}_{ij} - {\sum }_{k \neq j} \frac{{1}_{ik} {g}_{ik}}{{m}_{i} - 1} ) , \text{∀} j , \qquad ( 8 )$$

And in many embodiments, an item's quality is initiated by the equations:

$$\begin{matrix}{Q}_{i}^{0} = \frac{{\sum }_{j} \frac{{1}_{ij} ( {g}_{ij} - {b}_{j}^{0} )}{{( {σ}_{j}^{0} )}^{2}}}{{\sum }_{j} \frac{{1}_{ij}}{{( {σ}_{j}^{0} )}^{2}}} & ( 9 ) \\ {q}_{i}^{0} = {Q}_{i}^{0} + {\tilde{q}}^{0} - \frac{{\sum }_{{i}^{′}} {Q}_{{i}^{′}}^{0}}{n} ) . & ( 10 )\end{matrix}$$

The last equation rescales to normalize the estimated qualities.

In several embodiments, estimates of qualities are centered (305) at an overall mean quality, as best currently estimated. In particular embodiments, \tilde{q}^{t} is set to be the best current estimate of the overall average true quality through stage t,

$${\tilde{q}}^{t} = {\sum }_{i} \frac{1}{n} ( \frac{{\sum }_{j} \frac{{1}_{ij} {g}_{ij}}{{( {σ}_{j}^{t} )}^{2}}}{{\sum }_{j} \frac{{1}_{ij}}{{( {σ}_{j}^{t} )}^{2}}} ) .$$

Note that this particular normalization is very useful since it sets the overall average (item and accuracy weighted) estimated bias of the experts to be 0, and thus allows one to interpret bias, according to a number of embodiments.

In many embodiments, estimates of each rater's error and bias and of each item's quality are solved (307). In particular embodiments, each rater's error and bias and of each item's quality are solved using the equations:

$$\begin{matrix}{( {σ}_{j}^{t + 1} )}^{2} = {\sum }_{i} \frac{{1}_{ij} {( {g}_{ij} - {b}_{j}^{t} - {q}_{i}^{t} )}^{2}}{{n}_{j}} . & ( 11 ) \\ {b}_{j}^{t + 1} = {\sum }_{i} \frac{{1}_{ij} ( {g}_{ij} - {q}_{i}^{t} )}{{n}_{j}} , \text{∀} j . & ( 12 ) \\ {Q}_{i}^{t + 1} = \frac{{\sum }_{j} \frac{{1}_{ij} ( {g}_{ij} - {b}_{j}^{t + 1} )}{{( {σ}_{j}^{t + 1} )}^{2}}}{{\sum }_{j} \frac{{1}_{ij}}{{( {σ}_{j}^{t + 1} )}^{2}}} & ( 13 ) \\ {q}_{i}^{t} = {Q}_{i}^{t} + {\tilde{q}}^{t} - \frac{{\sum }_{{i}^{′}} {Q}_{{i}^{′}}^{t}}{n} ) . & ( 14 )\end{matrix}$$

In several embodiments, iterative computations at round t+1 as a function of the estimates from round t are solved, each iteration centering estimates of items' qualities to the best current estimate of overall average true quality. In a number of embodiments, an intrinsic true quality of each item, an accuracy and bias of each reviewer is determined (209) by iteratively centering estimates of qualities and resolving estimates of quality, error, and bias, and until convergence. In numerous embodiments, an optional estimation of precision of each item's estimated quality is determined (311). In particular embodiments, an associated estimate of the variance of quality estimate of item i, (σᵢ^{t})², is:

$$\frac{1}{{( {σ}_{i}^{t} )}^{2}} = {\sum }_{j} \frac{{1}_{ij}}{{( {σ}_{j}^{t} )}^{2}} , \qquad ( 15 )$$

This provides a level of confidence in the estimated true value of the item.

In accordance with more embodiments, a converged true intrinsic quality of each item and an error and bias of each reviewer are stored and/or reported (313). Furthermore, in a number of embodiments, normalized true intrinsic qualities may be used in many further downstream applications, including (but not limited to) monetary valuation and item marketing. In several embodiments, the accuracy and bias of each rater is used to evaluate each respective rater. Accordingly, numerous embodiments are also directed to the use of determined rater error and bias to incentivize raters to provide reliable ratings.

While specific examples of processes for determining the intrinsic qualities of items are described above, one of ordinary skill in the art can appreciate that various steps of the process can be performed in different orders and that certain steps may be optional according to some embodiments of the invention. As such, it should be clear that the various steps of the process could be used as appropriate to the requirements of specific applications. Furthermore, any of a variety of processes for determining the intrinsic qualities of items appropriate to the requirements of a given application can be utilized in accordance with various embodiments of the invention.

Several embodiments are also directed to a recommender system capable of recommending items based on a user's calculated bias. Accordingly, in many embodiments, a user could generate ratings of various items within a category. A recommender system, in accordance with numerous embodiments, could determine a particular user's bias, utilizing various embodiments described within. Based on a user's bias, according to several embodiments, a recommender system would recommend items that a user may prefer. For example, in the wine industry, a user may have an unrealized bias for wines having extraordinarily dry qualities (e.g., wines with high tannin content). Based on the user's reviews, a recommender system would be able to determine the user's bias for dry wines and make recommendations of wines with high tannin content.

### Systems of Intrinsic Quality Valuations

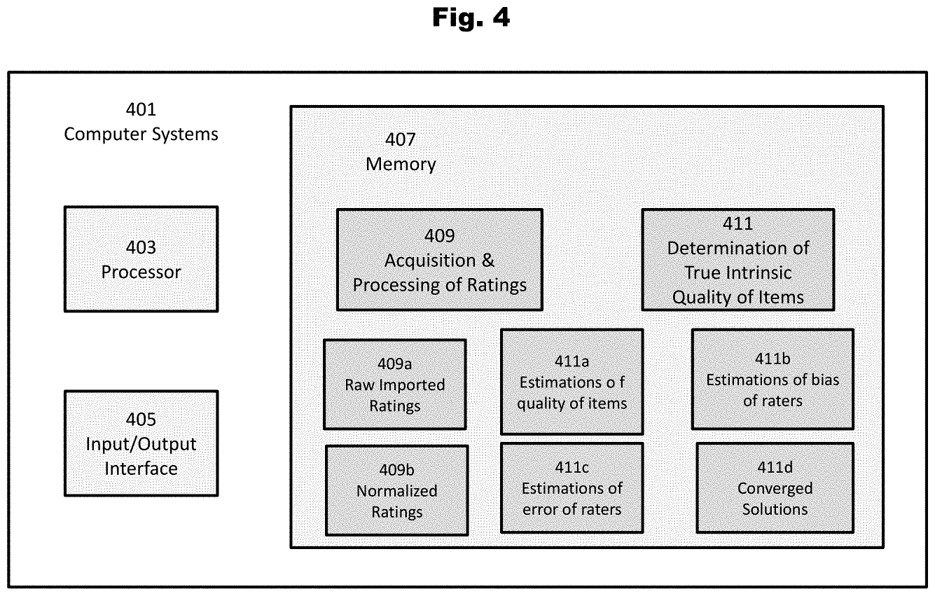

Turning now to FIG. 4, computer systems (401) may be implemented on computing devices in accordance with some embodiments of the invention. Computer systems (401) may include personal computers, laptop computers, other computing devices, or any combination of devices and computers with sufficient processing power for the processes described herein. Computer systems (401) include a processor (403), which may refer to one or more devices within the computing devices that can be configured to perform computations via machine readable instructions stored within a memory (407) of the computer systems (401). The processor may include one or more microprocessors (CPUs), one or more graphics processing units (GPUs), and/or one or more digital signal processors (DSPs). According to other embodiments of the invention, the computer system may be implemented on multiple computers.

In a number of embodiments of the invention, the memory (407) may contain an application for acquisition and processing of ratings (409) and an application for determination of true intrinsic qualities of items (411) that performs all or a portion of various methods according to different embodiments of the invention described throughout the present application. As an example, processor (403) may perform a ratings processing method and a quality determination method methods similar to any of the processes described above with reference to FIGS. 1 and 2, during which memory (407) may be used to store various intermediate processing data such as raw imported ratings (409a), normalized ratings (409b), estimations of quality of items (411a), estimations of error of raters (411b), estimations of bias of raters (411c), and converged solutions (411d).

In some embodiments of the invention, computer systems (401) may include an input/output interface (405) that can be utilized to communicate with a variety of devices, including but not limited to other computing systems, a projector, and/or other display devices. As can be readily appreciated, a variety of software architectures can be utilized to implement a computer system as appropriate to the requirements of specific applications in accordance with various embodiments of the invention.

Although computer systems and processes for variant analyses and performing actions based thereon are described above with respect to FIG. 4, any of a variety of devices and processes for data associated with variant analyses as appropriate to the requirements of a specific application can be utilized in accordance with many embodiments of the invention. Although the present invention has been described in certain specific aspects, many additional modifications and variations would be apparent to those skilled in the art. It is therefore to be understood that, the present invention may be practiced otherwise than specifically d escribed. Thus, embodiments of the p resent invention should be considered in all respects as illustrative and not restrictive.

### Exemplary Embodiments

A number of examples are provided to support the methods and systems of determining an intrinsic quality. In the ensuing section, exemplary calculations and applications related to intrinsic quality determination are provided.

### Example 1: Expert Ratings of Wines

Fine wines, and Bordeaux wines in particular, have attracted much interest from economists who aim to identify wine quality and its determinants. Wine is a typical product for which quality differences are simultaneously presumably very large (e.g., prices vary significantly) and difficult to appreciate (as p articular wine prices vary significantly from year to year, and even within year for different wines released by the same producer, and there are many producers). Official rankings and expertise have historically played a very important role in the development of these markets. However, experts' opinions have been shown to diverge even within relatively homogeneous sub-segments of the market.

Key parts of the Bordeaux fine wine industry operate via a futures/forwards market. At specific points in the season, wines that are not yet even bottled are tasted a nd rated by trained professionals and experts. Their ratings are vital for intermediaries and investors who will buy most of the production. Many of these ratings are eventually published in various media (magazines, books, websites). The wine will only be bottled and transferred to the buyers one to several years later (depending on the aging policy of the producer). The empirical study in this example focuses on such ratings of “en primeur” wines because these ratings are less likely to be polluted by cross influences and other information, as they are the first ratings and are essentially simultaneous.

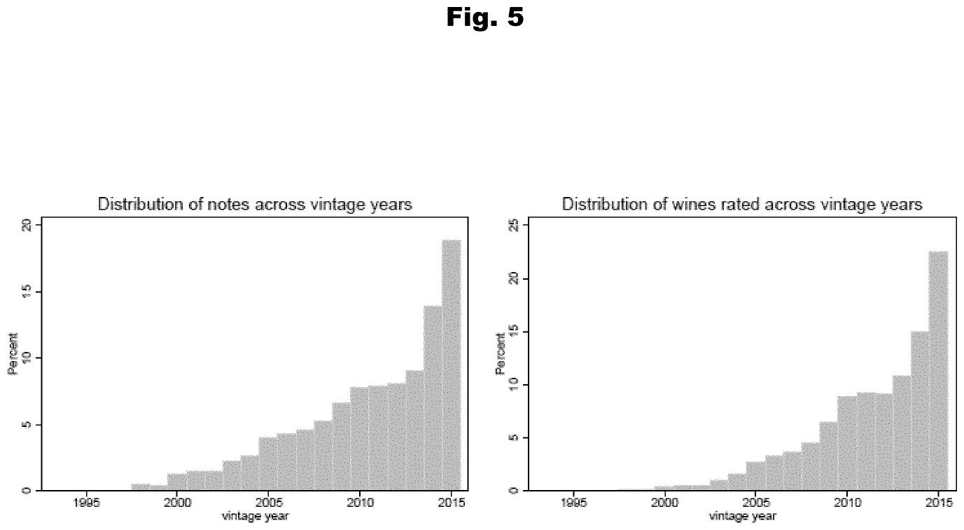

A database of 52,968 “en primeur” ratings from 19 experts was used for this study. They are wine critics, journalists, writers, and bloggers. Some like Robert Parker and Jancis Robinson are world-renowned critiques. In some cases an expert has issued multiple ratings of the same wine and vintage. In those cases, a mean rating was used. This results in 51,862 ratings. When the experts' ratings were rescaled to lie in the same interval (see below), the bottom five percent of the wines were dropped, which are often in a long bottom t ail of wines that are often somehow defective, sometimes idiosyncratically. This eliminates 1,825 wine/vintages. The analysis is robust to this dropping. Another 5687 wine/vintages were dropped that are rated by only one expert. In sum, 44,350 ratings of n=6,243 wine/vintages (with vintages from 1998 to 2015) given by the m=19 experts were used in this analysis (FIG. 5).

### Normalizing the Scales of Wines

Different wine experts use different scales for their ratings. For instance, Parker rates wines from 50 to 100, but essentially only ever rates between 70 and 100. Jancis Robinson employs a scale from 1 to 20 and usually rates between 10 to 20.

To adjust for these different scales, all experts ratings were converted to lie on a 0 to 100 scale and to use the whole scale. First, the lowest five percent of e ach expert's ratings were dropped, as the lower tail is quite long and noisy. Each expert's ratings was then linearly rescaled so that their lowest rated wine is given a rating of 0 and the highest rated wine is given a rating of 100.

Letting G denote the raw scores of the experts, the rescaled ratings are:

gᵢⱼ=100×(Gᵢⱼ−Gⱼ^{p5})/(Gⱼ^{p100}−Gⱼ^{p5}) (16)

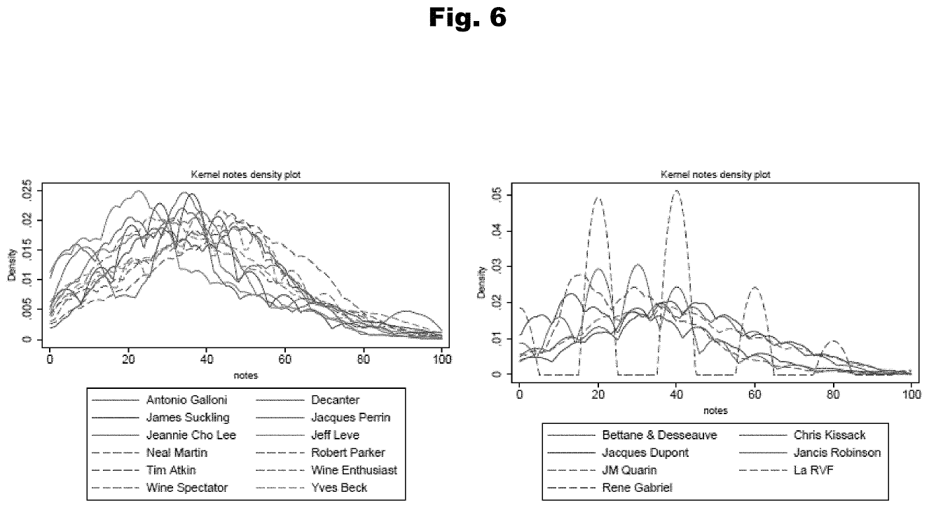

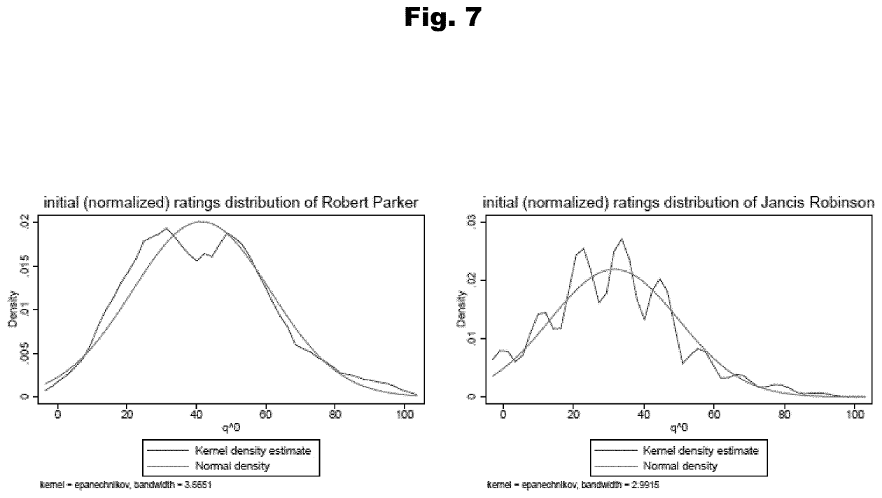

Given that some experts use a coarser scale than others, there are obvious peaks in their distribution. For instance, if they use a 20 point scale with half points rather than 100 point scale, then 19.5 becomes 97.5, 19 becomes 95, etc., and so there are clumps at certain points on the 100 point scale that are used (See FIGS. 6 and 7).

### Convergence and Intrinsic Qualities of Wine

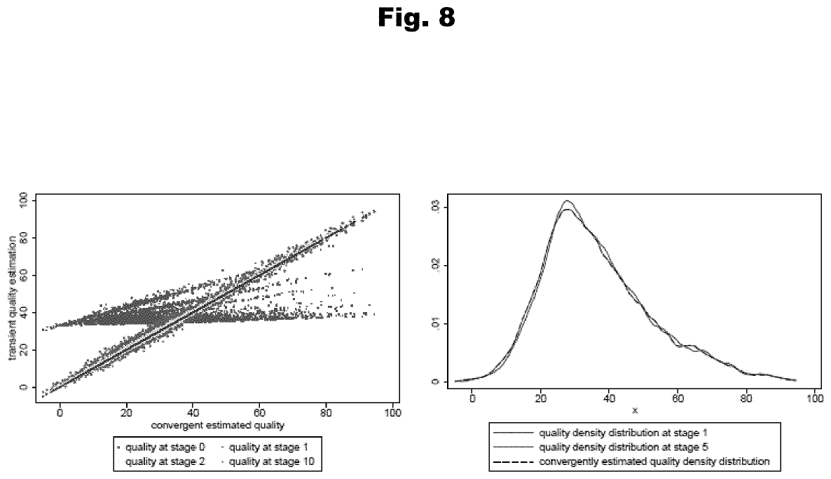

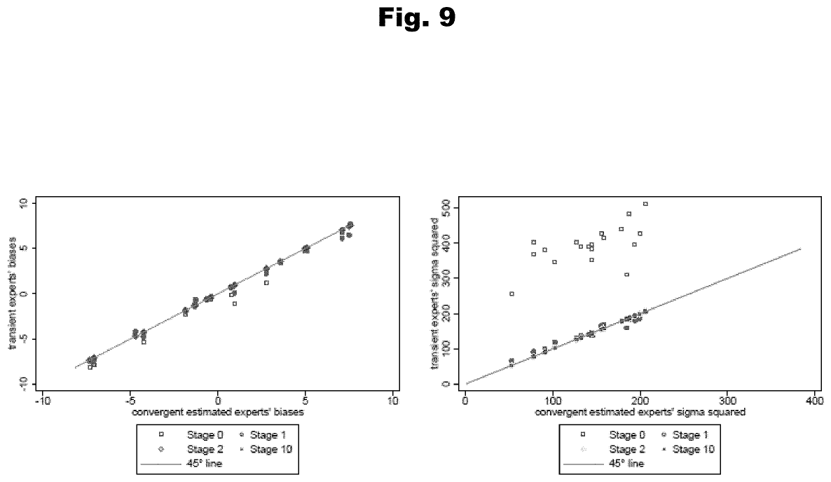

Convergence of the algorithm to the GMM solution was very rapid. Generally, the solution was reached after 5 to 10 iterations and full equality of the equations was hit and then there was no further movement of the remaining of the 100 iterations (See FIGS. 8 and 9).

The sensitivity of the estimations to a number of parts of the process was examined. For instance, the form of initial rescaling of the ratings or setting the initial experts qualities to unity have no significant impact on the results. Using the estimated sigma squared provided identical results.

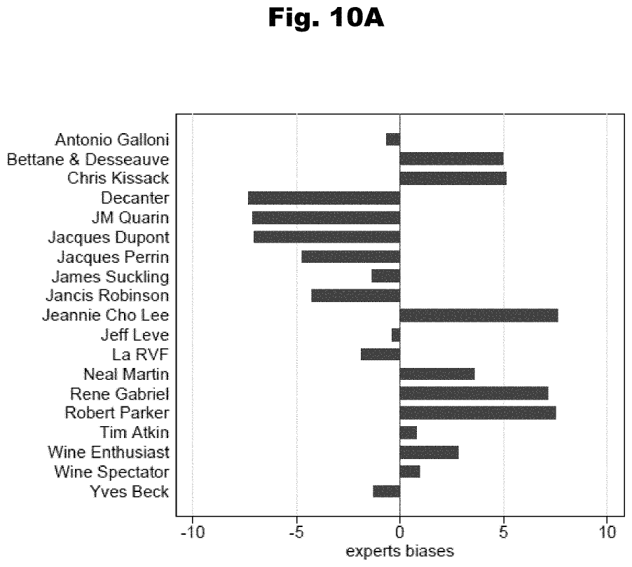

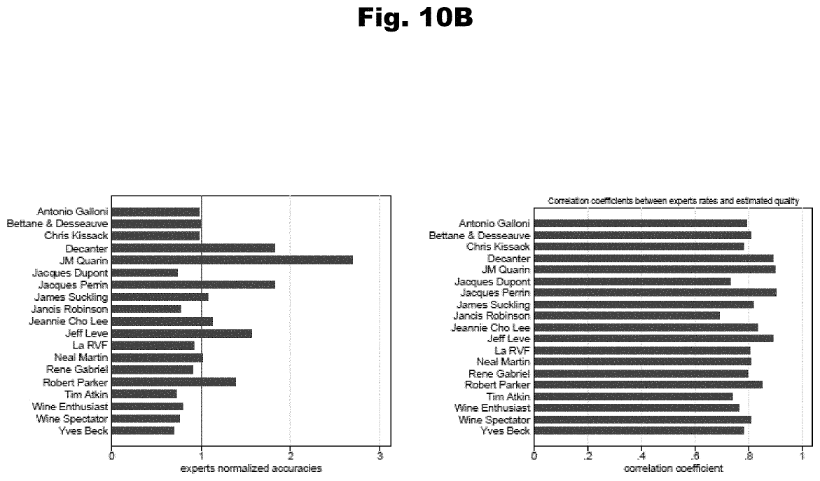

Provided in FIG. 10A are the biases of the experts.

As accuracy=1/\hat{σ}ⱼ² is hard to interpret directly, the formula was normalized by multiplying the average variance of the experts Σ_{j′}σ_{j′}²/m. Thus, an expert with an average accuracy will show up as having accuracy 1. An expert with accuracy 2 has twice the average precision, and so forth (FIG. 10B).

The correlation of an expert's ratings are with the estimated true quality of the wines s/he rates can also be measured. The correlation of an expert's prediction of the quality of a wine is related to the expert's accuracy.

Let σ_{q}² be the variance in the quality of a typical wine. Note that

Cov(qᵢ,gᵢⱼ)=Cov(qᵢ,qᵢ+bⱼ+εᵢⱼ)=Var(qᵢ)+Cov(qᵢ,εᵢⱼ)=σ_{q}².

### Therefore,

$$Corr ( {q}_{i} , {g}_{ij} ) = \frac{Cov ( {q}_{i} , {q}_{i} + {b}_{j} + {ɛ}_{ij} )}{{σ}_{q} \sqrt{Var ( {q}_{i} + {b}_{j} + {ɛ}_{ij} )}} = \frac{{σ}_{q}^{2}}{{σ}_{q} \sqrt{{σ}_{q}^{2} + {σ}_{j}^{2}}} = \frac{1}{\sqrt{1 + \frac{{σ}_{j}^{2}}{{σ}_{q}^{2}}}} .$$

Thus, since accuracy is

$$\frac{1}{{σ}_{j}^{2}}$$

and correlation is

$$\frac{1}{\sqrt{1 + \frac{{σ}_{j}^{2}}{{σ}_{q}^{2}}}} ,$$

the two are very similar functions.

Note that this correlation is not estimable without using this method, since one needs to estimate the quality of the wines to estimate the correlation of an expert's ratings with that quality.

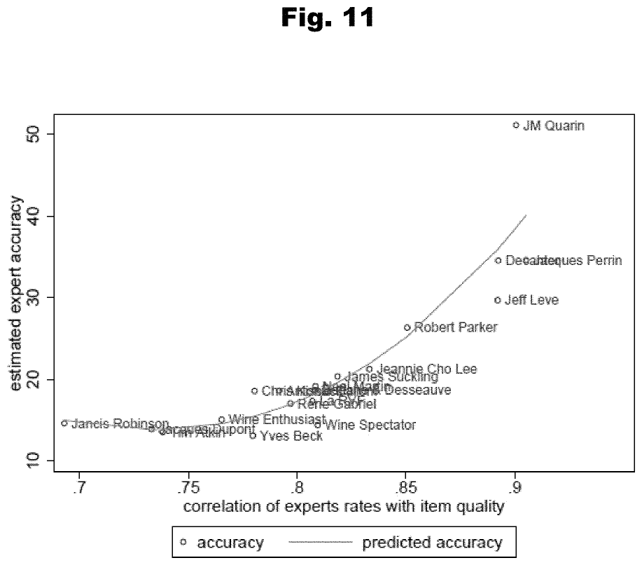

One can see this close relationship between accuracy and correlation in FIG. 11.

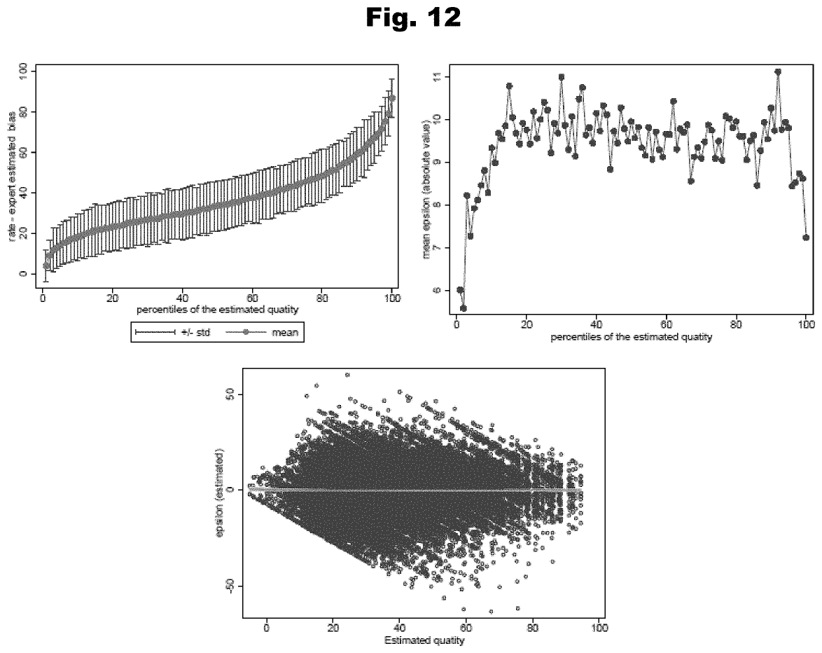

Recall that this model presumes that the experts' accuracies are independent of the quality of a wine—so they are just as good or bad at rating a high quality wine as a low quality wine. In essence it is assumed that qᵢ⊥εᵢⱼ∀i,j. One might, expect that experts' errors would increase when wines are of lower quality; or one might even expect the opposite. The relation between the estimated wine qualities and errors (Table 1. FIG. 12). One can see little relationship between errors and quality from the tenth to ninety-fifth percentile of item quality, that is for most middle-quality wines. There is a slight decrease of the average error for the highest and lowest five percent of rated wines.

TABLE 1
Experts’ Accuracies.

| expert | \hat{σ}ⱼ² | $normalized accuracy = \frac{{Σ}_{{j}^{′}} {\hat{σ}}_{{j}^{′}}^{2}}{{\hat{σ}}_{j}^{2}}$ | Corr (gᵢⱼ,\hat{q}ᵢ) | nⱼ |
|---|---|---|---|---|
| Antonio Galloni | 145.1364 | .8583284 | .7917423 | 954 |
| Bettane & Desseauve | 144.4908 | .8621639 | .8083333 | 2520 |
| Chris Kissack | 145.3225 | .8572295 | .7804236 | 1886 |
| Decanter | 78.21471 | 1.592728 | .8924085 | 1879 |
| JM Quarin | 52.87291 | 2.356116 | .90062 | 2402 |
| Jacques Dupont | 194.0192 | .6420742 | .7331077 | 2492 |
| Jacques Perrin | 78.1182 | 1.594695 | .9052212 | 419 |
| James Suckling | 132.6135 | .9393818 | .8185688 | 1650 |
| Jancis Robinson | 184.6749 | .6745623 | .6930351 | 2965 |
| Jeannie Cho Lee | 127.0811 | .9802777 | .833195 | 1001 |
| Jeff Leve | 91.018 | 1.368682 | .8921425 | 1336 |
| La RVF | 155.5768 | .8007281 | .8070636 | 1724 |
| Neal Martin | 141.0504 | .8831929 | .808379 | 2371 |
| Rene Gabriel | 158.4639 | .7861395 | .7969397 | 3972 |
| Robert Parker | 102.5979 | 1.214203 | .8505908 | 2461 |
| Tim Atkin | 199.3397 | .6249368 | .7382556 | 1506 |
| Wine Enthusiast | 179.049 | .6957576 | .7653303 | 2003 |
| Wine Spectator | 187.6129 | .6639986 | .8094715 | 2961 |
| Yves Beck | 205.9759 | .6048046 | .7796345 | 378 |

The top-100 wines from the sample along with their estimated qualities is provided in Table 2. The number one Bordeaux wine is actually a Sauterne (sweet white wine), Chateau Yquem 2009, and Chateau Marguaux 2010 is the best red wine.

As the determined qualities use the full 100 point scale and have an average in the 30's, the reported qualities may “look” unfair as most of the consumers and experts have the most known experts' ratings distribution in mind. For instance, most people have an idea of what an 80 or 90 point rating of a wine means according to Robert Parker. For instance, it would probably sounds weird to any professional in the fine wine industry to give a less than 90 point rating to a Lafite Rotschild 2010. To avoid potential misunderstanding due to interpreting wine qualities in the scales that, people are often used to, the quality ratings are also rescaled to place them back in the subregion of the 100 point scale usually used by wine experts—who rate almost all wines between 70 and 100. To do this, a “Parker-equivalent” quality level was calculated, which uses the same part of the scale that Parker usually uses.

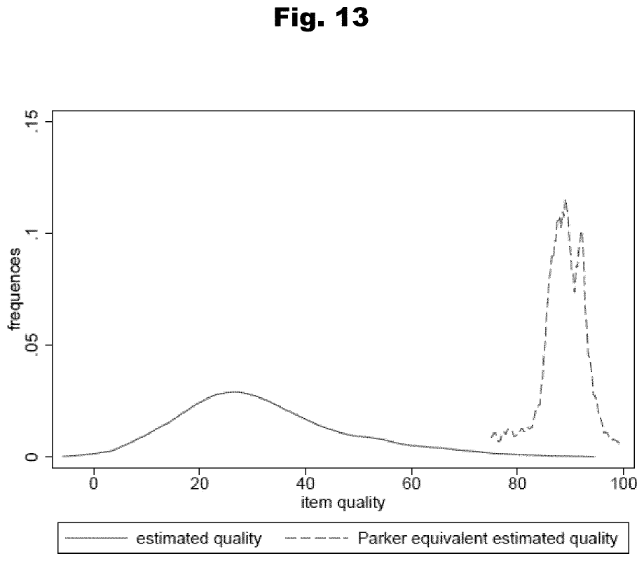

FIG. 13 shows how the distribution of ratings on the 100 points scale is modified when rescaled to a “Parker nominal view”. Note that this of course does not modify at all the ranking of the wines—it is just a shifting and renormalizing of the scale. This modified quality is reported in the second column (entitled “rescaled”) of Table 2.

As Bordeaux wineries are best-known for their red wines, a separate ranking restricted to that subsample is also provided. The results are presented in Tables 3 and 4.

TABLE 2
The top-100 rated Bordeaux wines.

| rank | \hat{q}ⱼ | Rescaled | wine | vintage | Type | appelation | classment |
|---|---|---|---|---|---|---|---|
| 1 | 94, 50 | 99, 5 | Yquem | 2009 | Sweet | Sauternes | Premier Cru Classe en 1855-Sauternes |
| 2 | 93, 69 | 99, 5 | Margaux | 2010 | Red | Margaux | Premier Cru Classe en 1855 |
| 3 | 92, 09 | 99, 5 | Yquem | 2015 | Sweet | Sauternes | Premier Cru Classe en 1855-Sauternes |
| 4 | 91, 74 | 99, 5 | Margaux | 2005 | Red | Margaux | Premier Cru Classe en 1855 |
| 5 | 91, 34 | 99, 5 | Margaux | 2009 | Red | Margaux | Premier Cru Classe en 1855 |
| 6 | 91, 26 | 99, 5 | Grand Vin de Latour | 2010 | Red | Pauillac | Premier Cru Classe en 1855 |
| 7 | 91, 11 | 99, 5 | Yquem | 2001 | Sweet | Sauternes | Premier Cru Classe en 1855-Sauternes |
| 8 | 90, 85 | 99, 5 | Grand Vin de Latour | 2009 | Red | Pauillac | Premier Cru Classe en 1855 |
| 9 | 90, 69 | 99, 5 | La Mission Haut Brion | 2000 | Red | Pessac Leognan | Grand Cru Classe de Graves (Rouge) |
| 10 | 90, 61 | 99, 5 | Yquem | 2005 | Sweet | Sauternes | Premier Cru Classe en 1855-Sauternes |
| 11 | 90, 40 | 99, 5 | Margaux | 2015 | Red | Margaux | Premier Cru Classe en 1855 |
| 12 | 88, 27 | 99, 5 | Lafite Rothschild | 2010 | Red | Pauillac | Premier Cru Classe en 1855 |
| 13 | 88, 19 | 99, 5 | Grand Vin de Latour | 2003 | Red | Pauillac | Premier Cru Classe en 1855 |
| 14 | 87, 90 | 99, 5 | Grand Vin de Latour | 2000 | Red | Pauillac | Premier Cru Classe en 1855 |
| 15 | 87, 77 | 99, 5 | Petrus | 2015 | Red | Pomerol | Grands Pomerol |
| 16 | 87, 51 | 99, 5 | Haut Brion | 2009 | Red | Pessac Leognan | Premier Cru Classe en 1855 |
| 17 | 87, 38 | 99, 5 | Ausone | 2015 | Red | Saint Emilion Grand Cru | Premier Cru Classe A |
| 18 | 87, 23 | 99, 5 | Lafite Rothschild | 2009 | Red | Pauillac | Premier Cru Classe en 1855 |
| 19 | 86, 91 | 99, 5 | Ausone | 2005 | Red | Saint Emilion Grand Cru | Premier Cru Classe A |
| 20 | 85, 63 | 99 | Petrus | 2009 | Red | Pemerol | Grands Pomerol |
| 21 | 85, 47 | 99 | Haut Brion | 2015 | Red | Pessac Leognan | Premier Cru Classe en 1855 |
| 22 | 85, 35 | 99 | Petrus | 2010 | Red | Pemerol | Grands Pomerol |
| 23 | 85, 21 | 99 | Cheval Blanc | 2010 | Red | Saint Emilion Grand Cru | Premier Cru Classe A |
| 24 | 84, 93 | 99 | Ausone | 2009 | Red | Saint Emilion Grand Cru | Premier Cru Classe A |
| 25 | 84, 91 | 99 | Cheval Blanc | 2015 | Red | Saint Emilion Grand Cru | Premier Cru Classe A |
| 26 | 84, 89 | 99 | Doisy Daene, l’Extravagant | 2009 | Sweet | Sauternes | Deuxieme Cru Classe en 1855 |
| 27 | 84, 86 | 99 | Grand Vin de Latour | 2005 | Red | Pauillac | Premier Cru Classe en 1855 |
| 28 | 84, 55 | 99 | Lafleur | 2015 | Red | Pomerol | Grands Pomerol |
| 29 | 83, 92 | 99 | Haut Brion | 2010 | Red | Pessac Leognan | Premier Cru Classe en 1855 |
| 30 | 83, 58 | 99 | Lafite Rothschild | 2003 | Red | Pauillac | Premier Cru Classe en 1855 |
| 31 | 83, 56 | 99 | Lafite Rothschild | 2005 | Red | Pauillac | Premier Cru Classe en 1855 |
| 32 | 83, 14 | 99 | Cheval Blanc | 2009 | Red | Saint Emilion Grand Cru | Premier Cru Classe A |
| 33 | 82, 81 | 99 | Rieussec | 2001 | Sweet | Sauternes | Premier Cru Classe en 1855-Sauternes |
| 34 | 82, 53 | 99 | Lafleur | 2009 | Red | Pomerol | Grands Pomerol |
| 35 | 82, 40 | 99 | Vieux Chateau Certan | 2010 | Red | Pomerol | Grands Pomerol |
| 36 | 82, 29 | 99 | Petrus | 1998 | Red | Pomerol | Grands Pomerol |
| 37 | 82, 24 | 99 | Eglise Clint | 2009 | Red | Pomerol | Grands Pomerol |
| 38 | 82, 13 | 99 | Petrus | 2005 | Red | Pomerol | Grands Pomerol |
| 39 | 81, 83 | 99 | Montrose | 2003 | Red | Saint Estephe | Deuxieme Cru Classe en 1855 |
| 40 | 81, 68 | 99 | Haut Brion | 2005 | Red | Pessac Leognan | Premier Cru Classe en 1855 |
| 41 | 81, 65 | 99 | Cheval Blanc | 2000 | Red | Saint Emilion Grand Cru | Premier Cru Classe A |
| 42 | 81, 54 | 99 | Yquem | 2014 | Sweet | Sauternes | Premier Cru Classe en 1855-Sauternes |
| 43 | 81, 34 | 99 | Mouton Rothschild | 2010 | Red | Pauillac | Premier Cru Classe en 1855 |
| 44 | 81, 01 | 99 | Ausone | 2003 | Red | Saint Emilion Grand Cru | Premier Cru Classe A |
| 45 | 80, 97 | 99 | Doisy Daene, l’Extravagant | 2010 | Sweet | Sauternes | Premier Cru Classe en 1855 |
| 46 | 80, 94 | 99 | Pavie | 2000 | Red | Saint Emilion Grand Cru | Premier Cru Classe A |
| 47 | 80, 89 | 99 | Mouton Rothschild | 2009 | Red | Pauillac | Premier Cru Classe en 1855 |
| 48 | 80, 79 | 99 | Leoville Las Cases | 2009 | Red | Saint Julien | Deuxieme Cru Classe en 1855 |
| 49 | 80, 67 | 99 | Leoville Barton | 2000 | Red | Saint Julien | Deuxieme Cru Classe en 1855 |
| 50 | 80, 65 | 99 | Cheval Blanc | 2005 | Red | Saint Emilion Grand Cru | Premier Cru Classe A |
| 51 | 80, 58 | 99 | Lafaurie Peyraguey | 2001 | Sweet | Sauternes | Premier Cru Classe en 1855-Sauternes |
| 52 | 80, 58 | 99 | Suduiraut | 2001 | Sweet | Sauternes | Premier Cru Classe en 1855-Sauternes |
| 53 | 80, 58 | 99 | Yquem | 2003 | Sweet | Sauternes | Premier Cru Classe en 1855-Sauternes |
| 54 | 80, 44 | 99 | Ausone | 2010 | Red | Saint Emilion Grand Cru | Premier Cru Classe A |
| 55 | 80, 31 | 99 | Yquem | 2007 | Sweet | Sauternes | Premier Cru Classe en 1855-Sauternes |
| 56 | 79, 71 | 99 | Grand Vin de Latour | 2015 | Red | Pauillac | Premier Cru Classe en 1855 |
| 57 | 79, 63 | 99 | Cos d’Estournel | 2003 | Red | Saint Estephe | Deuxieme Cru Classe en 1855 |
| 58 | 79, 63 | 99 | Lafleur | 2010 | Red | Pomerol | Grands Pomerol |
| 59 | 79, 54 | 99 | Leoville Las Cases | 2000 | Red | Saint Julien | Deuxieme Cru Classe en 1855 |
| 60 | 78, 91 | 99 | Climens | 2009 | Sweet | Sauternes | Premier Cru Classe en 1855-Sauternes |
| 61 | 78, 81 | 99 | Doisy Daene, l’Extravagant | 2011 | Sweet | Sauternes | Deuxieme Cru Classe en 1855 |
| 62 | 78, 52 | 99 | Troplong Mondot | 2005 | Red | Saint Emilion Grand Cru | Premier Cru Classe B |
| 63 | 78, 44 | 99 | Mouton Rothschild | 2015 | Red | Pauillac | Premier Cru Classe en 1855 |
| 64 | 78, 36 | 99 | Trotanoy | 1998 | Red | Pomerol | Grands Pomerol |
| 65 | 78, 26 | 99 | La Mission Haut Brion | 2010 | Red | Pessac Leognan | Grand Cru Classe de Graves (Rouge) |
| 66 | 78, 24 | 99 | Lafleur | 2005 | Red | Pomerol | Grands Pomerol |
| 67 | 78, 20 | 99 | Canon | 2015 | Red | Saint Emilion Grand Cru | Premier Cru Classe B |
| 68 | 78, 06 | 98 | Yquem | 2011 | Sweet | Sauternes | Premier Cru Classe en 1855-Sauternes |
| 69 | 78, 04 | 98 | La Mission Haut Brion | 2015 | Red | Pessac Leognan | Grand Cru Classe de Graves (Rouge) |
| 70 | 77, 81 | 98 | Palmer | 2009 | Red | Margaux | Troisieme Cru Classe en 1855 |
| 71 | 77, 77 | 98 | Palmer | 2015 | Red | Margaux | Troisieme Cru Classe en 1855 |
| 72 | 77, 77 | 98 | Vieux Chateau Certan | 2015 | Red | Pomerol | Grands Pomerol |
| 73 | 77, 44 | 98 | Eglise Clinet | 2010 | Red | Pomerol | Grands Pomerol |
| 74 | 77, 43 | 98 | Margaux | 2003 | Red | Margaux | Premier Cru Classe en 1855 |
| 75 | 77, 22 | 98 | Grand Vin de Latour | 2004 | Red | Pauillac | Premier Cru Classe en 1855 |
| 76 | 77, 14 | 98 | Doisy Daene, l’Extravagant | 2015 | Sweet | Sauternes | Deuxieme Cru Classe en 1855 |
| 77 | 76, 86 | 98 | Leoville Las Cases | 2005 | Red | Saint Julien | Deuxieme Cru Classe en 1855 |
| 78 | 76, 60 | 98 | Doisy Daene, l’Extravagant | 2006 | Sweet | Sauternes | Deuxieme Cru Classe en 1855 |
| 79 | 76, 52 | 98 | Pontet Canet | 2009 | Red | Pauillac | Cinquieme Cru Classe en 1855 |
| 80 | 76, 33 | 98 | Angelus | 2015 | Red | Saint Emilion Grand Cru | Premier Cru Classe A |
| 81 | 76, 22 | 98 | Ausone | 2008 | Red | Saint Emilion Grand Cru | Premier Cru Classe A |
| 82 | 75, 82 | 98 | Vieux Chateau Certan | 2009 | Red | Pomerol | Grands Pomerol |
| 83 | 73, 74 | 98 | Trotanoy | 2009 | Red | Pemerol | Grands Pomerol |
| 84 | 75, 73 | 98 | La Mission Haut Brion | 2009 | Red | Pessac Leognan | Grand Cru Classe de Graves (Rouge) |
| 85 | 73, 72 | 98 | Doisy Daene, l’Extravagant | 2005 | Sweet | Sauternes | Deuxieme Cru Classe en 1855 |
| 86 | 75, 63 | 98 | Leoville Las Cases | 2010 | Red | Saint Julien | Deuxieme Cru Classe en 1855 |
| 87 | 73, 37 | 97, 5 | Petrus | 2012 | Red | Pemerol | Grands Pomerol |
| 88 | 75, 56 | 97, 5 | Yquem | 2010 | Sweet | Sauternes | Premier Cru Classe en 1855-Sauternes |
| 89 | 73, 44 | 97, 5 | Yquem | 2006 | Sweet | Sauternes | Premier Cru Classe en 1855-Sauternes |
| 90 | 75, 26 | 97, 5 | Palmer | 2010 | Red | Margaux | Troisieme Cru Classe en 1855 |
| 91 | 75, 18 | 97, 5 | Cos d’Estournel | 2010 | Red | Saint Estephe | Deuxieme Cru Classe en 1855 |
| 92 | 75, 11 | 97, 5 | Eglise Clinet | 2015 | Red | Pomerol | Grands Pomerol |
| 93 | 73, 10 | 97, 5 | Pavie | 2003 | Red | Saint Emilion Grand Cru | Premier Cru Classe A |
| 94 | 75, 06 | 97, 5 | Grand Vin de Latour | 2014 | Red | Pauillac | Premier Cru Classe en 1855 |
| 93 | 74, 85 | 97, 5 | Yquem | 2004 | Sweet | Sauternes | Premier Cru Classe en 1855-Sauternes |
| 96 | 74, 83 | 97, 5 | Montrose | 2009 | Red | Saint Estephe | Deuxieme Cru Classe en 1855 |
| 97 | 74, 78 | 97, 5 | Haut Bailly | 2015 | Red | Pessac Leognan | Grand Cru Classe de Graves (Rouge) |
| 98 | 74, 64 | 97, 5 | Doisy Daene, l’Extravagant | 2003 | Sweet | Sauternes | Deuxieme Cru Classe en 1855 |
| 99 | 74, 60 | 97, 5 | Pavie | 2015 | Red | Saint Emilion Grand Cru | Premier Cru Classe A |
| 100 | 74, 46 | 97, 5 | Climens | 2005 | Sweet | Sauternes | Premier Cru Classe en 1855-Sauternes |

TABLE 3
Ranking experts for red Bordeaux only.

| expert | \hat{σ}ⱼ² | $normalized accuracy = \frac{{Σ}_{{j}^{′}} {\hat{σ}}_{{j}^{′}}^{2}}{{\hat{σ}}_{j}^{2}}$ | Corr (gᵢⱼ,\hat{q}ᵢ) | nⱼ |
|---|---|---|---|---|
| Antonio Galloni | 145.1364 | .8583284 | .7917423 | 954 |
| Bettane & Desseauve | 144.4908 | .8621639 | .8083333 | 2520 |
| Chris Kissack | 145.3225 | .8572295 | .7804236 | 1886 |
| Decanter | 78.21471 | 1.592728 | .8924085 | 1879 |
| JM Quarin | 52.87291 | 2.356116 | .90062 | 2402 |
| Jacques Dupont | 194.0192 | .6420742 | .7331077 | 2492 |
| Jacques Perrin | 78.1182 | 1.594695 | .9052212 | 419 |
| James Suckling | 132.6135 | .9393818 | .8185688 | 1650 |
| Jancis Robinson | 184.6749 | .6745623 | .6930351 | 2965 |
| Jeannie Cho Lee | 127.0811 | .9802777 | .833195 | 1001 |
| Jeff Leve | 91.018 | 1.368682 | .8921425 | 1336 |
| La RVF | 155.5768 | .8007281 | .8070636 | 1724 |
| Neal Martin | 141.0504 | .8831929 | .808379 | 2371 |
| Rene Gabriel | 158.4639 | .7861395 | .7969397 | 3972 |
| Robert Parker | 102.5979 | 1.214203 | .8505908 | 2461 |
| Tim Atkin | 199.3397 | .6249368 | .7382556 | 1506 |
| Wine Enthusiast | 179.049 | .6957576 | .7653303 | 2003 |
| Wine Spectator | 187.6129 | .6639986 | .8094715 | 2961 |
| Yves Beck | 205.9752 | .6048046 | .7796145 | 378 |

TABLE 4
The top-100 rated Bordeaux red wines.

| rank | \hat{q}ⱼ | Rescaled | wine | vintage | appelation | classement |
|---|---|---|---|---|---|---|
| 1 | 94, 50 | 99, 5 | Margaux | 2010 | Margaux | Premier Cru Classe en 1855 |
| 2 | 93, 05 | 99, 5 | Margaux | 2005 | Margaux | Premier Cru Classe en 1855 |
| 3 | 92, 16 | 99, 5 | Grand Vin de Latour | 2010 | Pauillac | Premier Cru Classe en 1855 |
| 4 | 91, 98 | 99, 5 | Margaux | 2009 | Margaux | Premier Cru Classe en 1855 |
| 5 | 91, 32 | 99, 5 | Grand Vin de Latour | 2009 | Pauillac | Premier Cru Classe en 1855 |
| 6 | 90, 96 | 99, 5 | Margaux | 2015 | Margaux | Premier Cru Classe en 1855 |
| 7 | 90, 94 | 99, 5 | La Mission Haut Brion | 2000 | Pessac Leognan | Grand Cru Classe de Graves (Rouge) |
| 8 | 88, 62 | 99, 5 | Lafite Rothschild | 2010 | Pauillac | Premier Cru Classe en 1855 |
| 9 | 88, 41 | 99, 5 | Haut Brion | 2009 | Pessac Leognan | Premier Cru Classe en 1855 |
| 10 | 88, 38 | 99, 5 | Petrus | 2015 | Pomerol | Grands Pomerol |
| 11 | 88, 38 | 99, 5 | Grand Vin de Latour | 2003 | Pauillac | Premier Cru Classe en 1855 |
| 12 | 88, 18 | 99, 5 | Grand Vin de Latour | 2000 | Pauillac | Premier Cru Classe en 1855 |
| 13 | 88, 04 | 99, 5 | Ausone | 2015 | Saint Emilion Grand Cru | Premier Cru Classe A |
| 14 | 87, 72 | 99, 5 | Ausone | 2005 | Saint Emilion Grand Cru | Premier Cru Classe A |
| 15 | 87, 35 | 99, 5 | Lafite Rothschild | 2009 | Pauillac | Premier Cru Classe en 1855 |
| 16 | 86, 34 | 99 | Petrus | 2009 | Pomerol | Grands Pomerol |
| 17 | 86, 04 | 99 | Haut Brion | 2015 | Pessac Leognan | Premier Cru Classe en 1855 |
| 18 | 85, 05 | 99 | Petrus | 2010 | Pomerol | Grands Pomerol |
| 19 | 85, 90 | 99 | Cheval Blanc | 2010 | Saint Emilion Grand Cru | Premier Cru Classe A |
| 20 | 85, 83 | 99 | Ausone | 2009 | Saint Emilion Grand Cru | Premier Cru Classe A |
| 21 | 85, 69 | 99 | Cheval Blanc | 2015 | Saint Emilion Grand Cru | Premier Cru Classe A |
| 22 | 85, 00 | 99 | Grand Vin de Latour | 2005 | Pauillac | Premier Cru Classe en 1855 |
| 23 | 84, 97 | 99 | Lafleur | 2015 | Pomerol | Grands Pomerol |
| 24 | 84, 67 | 99 | Lafite Rothschild | 2003 | Pauillac | Premier Cru Classe en 1855 |
| 25 | 84, 45 | 99 | Lafite Rothschild | 2005 | Pauillac | Premier Cru Classe en 1855 |
| 26 | 84, 37 | 99 | Haut Brion | 2010 | Pessac Leognan | Premier Cru Classe en 1855 |
| 27 | 83, 75 | 99 | Cheval Blanc | 2009 | Saint Emilion Grand Cru | Premier Cru Classe A |
| 28 | 83, 14 | 99 | Eglise Clinet | 2009 | Pomerol | Grands Pomerol |
| 29 | 83, 12 | 99 | Petrus | 2005 | Pomerol | Grands Pomerol |
| 30 | 82, 97 | 99 | Vieux Chateau Certan | 2010 | Pomerol | Grands Pomerol |
| 31 | 82, 95 | 99 | Lafleur | 2009 | Pomerol | Grands Pomerol |
| 32 | 82, 74 | 99 | Montrose | 2003 | Saint Estephe | Deuxieme Cru Classe en 1855 |
| 33 | 82, 29 | 99 | Petrus | 1998 | Pomerol | Grands Pomerol |
| 34 | 82, 03 | 99 | Ausone | 2003 | Saint Emilion Grand Cru | Premier Cru Classe A |
| 35 | 81, 95 | 99 | Cheval Blanc | 2000 | Saint Emilion Grand Cru | Premier Cru Classe A |
| 36 | 81, 74 | 99 | Mouton Rothschild | 2010 | Pauillac | Premier Cru Classe en 1855 |
| 37 | 81, 65 | 99 | Haut Brion | 2005 | Pessac Leognan | Premier Cru Classe en 1855 |
| 38 | 81, 44 | 99 | Mouton Rothschild | 2009 | Pauillac | Premier Cru Classe en 1855 |
| 39 | 81, 27 | 99 | Pavie | 2000 | Saint Emilion Grand Cru | Premier Cru Classe A |
| 40 | 81, 19 | 99 | Cheval Blanc | 2005 | Saint Emilion Grand Cru | Premier Cru Classe A |
| 41 | 80, 98 | 99 | Leoville Las Cases | 2009 | Saint Julien | Deuxieme Cru Classe en 1855 |
| 42 | 80, 90 | 99 | Leoville Barton | 2000 | Saint Julien | Deuxieme Cru Classe en 1855 |
| 43 | 80, 89 | 99 | Ausone | 2010 | Saint Emilion Grand Cru | Premier Cru Classe en 1855 |
| 44 | 80, 86 | 99 | Troplong Mondot | 2005 | Saint Emilion Grand Cru | Premier Cru Classe B |
| 45 | 80, 69 | 99 | Cos d’Estournel | 2003 | Saint Estephe | Deuxieme Cru Classe en 1855 |
| 46 | 80, 40 | 99 | Lafleur | 2010 | Pomerol | Grands Pomerol |
| 47 | 80, 35 | 99 | Grand Vin de Latour | 2015 | Pauillac | Premier Cru Classe en 1855 |
| 48 | 79, 89 | 99 | Leoville Las Cases | 2000 | Saint Julien | Deuxieme Cru Classe en 1855 |
| 49 | 78, 90 | 99 | Mouton Rothschild | 2015 | Pauillac | Premier Cru Classe en 1855 |
| 50 | 78, 81 | 99 | La Mission Haut Brion | 2015 | Pessac Leognan | Grand Cru Classe de Graves (Rouge) |
| 51 | 78, 80 | 98 | Canon | 2015 | Saint Emilion Grand Cru | Premier Cru Classe B |
| 52 | 78, 72 | 98 | La Mission Haut Brion | 2010 | Pessac Leognan | Grand Cru Classe de Graves (Rouge) |
| 53 | 78, 65 | 98 | Lafleur | 2005 | Pomerol | Grands Pomerol |
| 54 | 78, 50 | 98 | Palmer | 2009 | Margaux | Troisieme Cru Classe en 1855 |
| 55 | 78, 49 | 98 | Margaux | 2003 | Margaux | Premier Cru Classe en 1855 |
| 56 | 78, 37 | 98 | Trotanoy | 1998 | Pomerol | Grands Pomerol |
| 57 | 78, 30 | 98 | Palmer | 2115 | Margaux | Troisieme Cru Classe en 1855 |
| 58 | 78, 17 | 98 | Eglise Clinet | 2010 | Pomerol | Grands Pomerol |
| 59 | 77, 96 | 98 | Vieux Chateau Certan | 2115 | Pomerol | Grands Pomerol |
| 60 | 77, 79 | 98 | Leoville Las Cases | 2005 | Saint Julien | Deuxieme Cru Classe en 1855 |
| 61 | 77, 47 | 98 | Grand Vin de Latour | 2004 | Pauillac | Premier Cru Classe en 1855 |
| 62 | 77, 24 | 98 | Angelus | 2015 | Saint Emilion Grand Cru | Premier Cru Classe A |
| 63 | 76, 67 | 98 | Pontet Canet | 2009 | Pauillac | Cinquieme Cru Classe en 1855 |
| 64 | 76, 62 | 98 | Leoville Las Cases | 2010 | Saint Julien | Deuxieme Cru Classe en 1855 |
| 65 | 76, 53 | 98 | Vieux Chateau Certan | 2009 | Pomerol | Grands Pomerol |
| 66 | 76, 49 | 98 | La Mission Haut Brion | 2009 | Pessac Leognan | Grand Cru Classe de Graves (Rouge) |
| 67 | 76, 36 | 97, 5 | Ausone | 2008 | Saint Emilion Grand Cru | Premier Cru Classe A |
| 68 | 75, 85 | 97, 5 | Cos d’Estournel | 2010 | Saint Estephe | Deuxieme Cru Classe en 1855 |
| 69 | 75, 81 | 97, 5 | Petrus | 2112 | Pomerol | Grands Pomerol |
| 70 | 75, 68 | 97, 5 | Palmer | 2010 | Margaux | Troisieme Cru Classe en 1855 |
| 71 | 75, 64 | 97, 5 | Eglise Clinet | 2015 | Pomerol | Grands Pomerol |
| 72 | 75, 61 | 97, 5 | Lafite Rothschild | 2000 | Pauillac | Premier Cru Classe en 1855 |
| 73 | 75, 61 | 97, 5 | Mouton Rothschild | 2002 | Pauillac | Premier Cru Classe en 1855 |
| 74 | 75, 59 | 97, 5 | Trotanoy | 2009 | Pomerol | Grands Pomerol |
| 75 | 75, 59 | 97, 5 | Grand Vin de Latour | 2014 | Pauillac | Premier Cru Classe en 1855 |
| 76 | 75, 58 | 97, 5 | Pavie | 2005 | Saint Emilion Grand Cru | Premier Cru Classe A |
| 77 | 75, 39 | 97, 5 | Pavie | 2015 | Saint Emilion Grand Cru | Premier Cru Classe A |
| 78 | 75, 28 | 97, 5 | Haut Bailly | 2015 | Pessac Leognan | Grand Cru Classe de Graves (Rouge) |
| 79 | 75, 23 | 97, 5 | Montrose | 2009 | Saint Estephe | Deuxieme Cru Classe en 1855 |
| 80 | 74, 74 | 97, 5 | Mouton Rothschild | 2006 | Pauillac | Premier Cru Classe en 1855 |
| 81 | 74, 55 | 97, 5 | Le Pin | 2010 | Pomerol | Grands Pomerol |
| 82 | 74, 45 | 97, 5 | Haut Brion | 1998 | Pessac Leognan | Premier Cru Classe en 1855 |
| 83 | 74, 45 | 97, 5 | Vieux Chateau Certan | 1998 | Pomerol | Grands Pomerol |
| 84 | 74, 45 | 97, 5 | Lafite Rothschild | 2015 | Pauillac | Premier Cru Classe en 1855 |
| 81 | 74. 43 | 97, 5 | Leoville Las Cases | 2015 | Saint Julien | Deuxieme Cru Classe en 1855 |
| 86 | 74, 35 | 97, 5 | Figeac | 2015 | Saint Emilion Grand Cru | Premier Cru Classe B |
| 87 | 74, 22 | 97, 5 | Cos d’Estournel | 2005 | Saint Estephe | Deuxieme Cru Classe en 1855 |
| 88 | 74, 13 | 97, 5 | Palmer | 2005 | Margaux | Troisieme Cru Classe en 1855 |
| 89 | 74, 06 | 97, 5 | Ducru Beaucaillou | 2015 | Saint Julien | Deuxieme Cru Classe en 1855 |
| 90 | 73, 99 | 97, 5 | Lynch Bages | 2000 | Pauillac | Cinquieme Cru Classe en 1855 |
| 91 | 73, 99 | 97, 5 | Margaux | 2000 | Margaux | Premier Cru Classe en 1855 |
| 92 | 73, 99 | 97, 5 | Evangile | 2000 | Pomerol | Grands Pomerol |
| 93 | 73, 88 | 97, 5 | Ducru Beaucaillou | 2009 | Saint Julien | Deuxieme Cru Classe en 1855 |
| 94 | 73, 81 | 97, 5 | Ducru Beaucaillou | 2010 | Saint Julien | Deuxieme Cru Classe en 1855 |
| 95 | 73, 80 | 97, 5 | Trotanoy | 2015 | Pomerol | Grands Pomerol |
| 96 | 73, 78 | 97, 5 | Trotanoy | 2010 | Pomerol | Grands Pomerol |
| 97 | 73, 76 | 97, 5 | Pichon Baron | 2010 | Pauillac | Deuxieme Cru Classe en 1855 |
| 98 | 73, 62 | 97, 5 | Margaux | 2006 | Margaux | Premier Cru Classe en 1855 |
| 99 | 73, 55 | 97 | Pontet Canet | 2010 | Pauillac | Cinquieme Cru Classe en 1855 |
| 100 | 73, 14 | 97 | Lafite Rothschild | 2002 | Pauillac | Premier Cru Classe en 1855 |

### Example 2: Establishing Price Based on Intrinsic Quality

Generally, there is a textbook identification problem that stems from the fact that prices are determined by both supply and demand, which can both move to affect prices. Here, identification comes from the fact that prices are largely determined after the amount of wine supplied is already largely fixed, and then the quality of the wine is later made known and prices result. Thus, supply is treated as inelastic, and prices reflecting perceived quality. Moreover, by including various fixed effects, it is deviations in prices that are being attributed to relative qualities of the wines.

Prices cannot simply be regressed on the estimated quality because other factors influence the posted prices. For instance, shops' attributes, vintages, local production origins (AOC) and official rankings are clearly observed by the consumers and are likely to affect the prices, holding wine quality constant. Even if these variables are also correlated with unobserved quality, it is possible to control for them to obtain a lower bound of the correlation between the calculated quality and prices.

Consumers may also observe and be directly influenced by some experts' ratings. In the wine industry, it has been shown that. Parker ratings have a direct and significant impact on prices. Omitting such variables could lead prices to correlate with the estimated quality simply because the quality estimates are also positively correlated with expert ratings that consumers and wine shops observe. The problem reverses a traditional question addressed in the wine economics literature which aims to identify the causal impact of the ratings on the prices when wine quality is unobserved. Instead, the relationship between our calculated wine quality and prices is estimated, and then controlled for salient information.

In the Bordeaux wine industry, quantities are completely fixed for a given vintage (production cannot be significantly adjusted upward by mixing the wine of that vintage with wine from other vintages). The main adjustment to an increased individualized demand is thus on the price. Thus, an hedonic (price) regression is estimated.

It has been shown that wine prices are affected by the weather conditions at, crucial points in the season in the production year and by wine aging. Such weather conditions were controlled for by including vintage-appellation fixed effects: dummies that capture the weather conditions for various vintages in the specific sub-region of Bordeaux production. The sale year and retail shop fixed effects were also included, which can influence the observed prices. An ‘official ranking’ fixed effects was included. (see Table 5).

TABLE 5
Official rankings

| | number of | number of |
|---|---|---|
| Classement (official ranking) | wines/vintages | ratings |
| — | 1978 | 10392 |
| Cinquieme Cru Classe en 1855 | 303 | 2757 |
| Deuxieme Cru Classe en 1855 | 240 | 2315 |
| Grand Cru Assimile-Medoc | 302 | 2304 |
| Grand Cru Classe de Graves (Rouge) | 199 | 1812 |
| Grand Cru Classe de St Emilion | 837 | 5471 |
| Grands Pomerol | 346 | 2982 |
| Premier Cru Classe A | 72 | 671 |
| Premier Cru Classe B | 233 | 2162 |
| Premier Cru Classe en 1855 | 90 | 871 |
| Quatrieme Cru Classe en 1855 | 165 | 1506 |
| Seconds Vins | 191 | 1587 |
| Troisieme Cru Classe en 1855 | 229 | 2050 |

Ratings of well-known experts are likely a direct impact on prices. Accordingly, in this exemplary method the salient “reference” experts' ratings are controlled by directly including the ratings of the best-known expert for Bordeaux fine wines, Robert Parker. The ratings of Jancis Robinson, who is another big name for Bordeaux wines, were also included.

In some regressions, the “best” rating of each wine was also controlled for, as in retail stores, sellers often transmit to the consumers the most favorable piece of information so as to influence their decisions.

Lastly, as a limit experiment, the average rating among experts (properly normalized) was used as a supplementary control to check whether the estimated quality still significantly explains price variation when controlling for the average rating. All the ratings used are corrected to span the 1-100 scale as exposed in Equation 16).

### Pricing of Wine

The Bordeaux wine “terroir” is typically documented by sub appellations such as Medoc, Saint Emilion, Premieres Cotes de Bordeaux or Pauillac. These appellations are very much linked to the notion of terroir as they relate to specific sub-regions of production as well as (most of the time) typical production constraints (types of grapes, specific production quantifies per hectares . . . ). The Bordeaux wine is also associated to official ranking such as Grand Cru Classe 1855 or Premier Grand Cru (see Table 5).

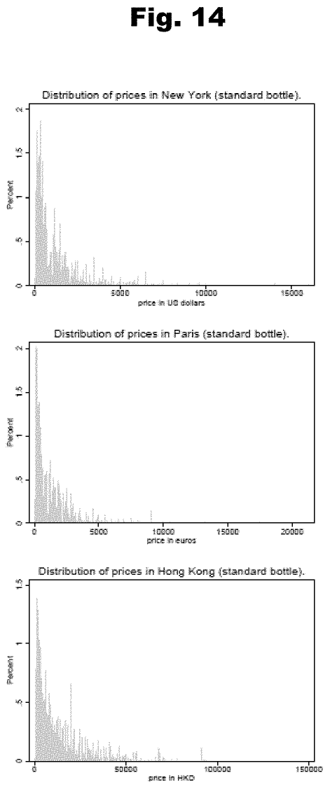

The prices of the wines are from surveys of restaurants in three of the main worldwide markets: in Hong Kong, N.Y. and Paris (Table 6, FIG. 14). The prices were recorded between 2010 and 2016. Initially, 93,466 prices of standard bottle Bordeaux wines were recorded.

Each wine/vintage rated en primeur was matched with all posterior prices and obtained a database of wine/vintage prices observations, in a given shop and year. Out of the 2,439 wine/vintage that were considered, there were 39,678 such observations, that is 16.27 prices on average for each wine/vintage (Table 7).

TABLE 6
Markets surveyed, stores and prices

| Market | Number of stores | Number of wines | Number of prices |
|---|---|---|---|
| Hong Kong | 216 | 5926 | 12131 |
| New York | 338 | 6702 | 11089 |
| Paris | 351 | 9696 | 16488 |

TABLE 7
Wines by Appellation

| | number of | number of |
|---|---|---|
| appelation | wines/vintages | ratings |
| Blaye | 4 | 17 |
| Bordeaux | 18 | 79 |
| Bordeaux Superieur | 39 | 179 |
| Canon Fronsac | 10 | 56 |
| Castillon Cotes de Bordeaux | 2 | 18 |
| Cotes de Blaye | 3 | 8 |
| Cotes de Bordeaux | 3 | 14 |
| Cotes de Bourg | 15 | 64 |
| Cotes de Castillon | 64 | 394 |
| Cotes de Franc | 8 | 63 |
| Entre deux mers | 4 | 19 |
| Fronsac | 64 | 316 |
| Graves | 77 | 307 |
| Haut Medoc | 292 | 1731 |
| Lalande de Pomerol | 81 | 472 |
| Listrac Medoc | 63 | 361 |
| Lussac Saint Emilion | 13 | 36 |
| Margaux | 497 | 3991 |
| Medoc | 123 | 593 |
| Montagne Saint Emilion | 14 | 50 |
| Moulis en Medoc | 62 | 425 |
| Pauillac | 436 | 3840 |
| Pessac Leognan | 427 | 3487 |
| Pomerol | 647 | 4658 |
| Premieres Cotes de Blaye | 4 | 17 |
| Premieres Cotes de Bordeaux | 22 | 95 |
| Puisseguin Saint Emilion | 12 | 59 |
| Saint Emilion | 450 | 2344 |
| Saint Emilion Grand Cru | 1153 | 8343 |
| Saint Estephe | 272 | 2173 |
| Saint Georges Saint Emilion | 1 | 2 |
| Saint Julien | 300 | 2632 |
| Sainte Foy Bordeaux | 4 | 29 |
| Vin de Table | 1 | 8 |

FIG. 14 shows the price distributions in the three markets. Table 8 lists the top-100 most surveyed restaurants in the data.

TABLE 8
Top 100 most surveyed stores (restaurants)

| Store | Market | Number of Wines | Number of Prices |
|---|---|---|---|
| L'Atelier de Joel Robuchon - HK | Hong Kong | 429 | 1607 |
| La Truffiere | Paris | 409 | 1270 |
| Le Cinq - Paris | Paris | 288 | 581 |
| Le Carre des Feuillants | Paris | 272 | 1077 |
| Apicius | Paris | 272 | 397 |
| Le Pre Catelan | Paris | 263 | 431 |
| Petrus - HK | Hong Kong | 237 | 917 |
| Epicure | Paris | 234 | 370 |
| Cepage | Hong Kong | 223 | 507 |
| L Abeille (Shangri-La) | Paris | 190 | 558 |
| Per Se | New York | 172 | 265 |
| KO Dining Group (Messina, Yu Lei, Kazuo Okuda) | Hong Kong | 171 | 608 |
| Mandarin Oriental Paris - Sur Mesure, Camelia | Paris | 159 | 411 |
| Le Meurice | Paris | 156 | 410 |
| 21 Club | New York | 154 | 394 |
| Shang Palace (Shangri-La) - Paris | Paris | 154 | 282 |
| Au Trou Gascon | Paris | 147 | 505 |
| The Steak House winebar + grill | Hong Kong | 137 | 321 |
| Alain Ducasse au Plaza Athenee | Paris | 136 | 326 |
| Spoon | Hong Kong | 136 | 281 |
| Le relais du plaza (plaza athenee) | Paris | 132 | 149 |
| Le Grand Vefour | Paris | 131 | 276 |
| Yan Toh Heen | Hong Kong | 129 | 241 |
| The Modern | New York | 129 | 180 |
| Aureole | New York | 128 | 246 |
| Amber | Hong Kong | 125 | 191 |
| Blt Steak | New York | 124 | 171 |
| Le Diane | Paris | 118 | 232 |
| Pierre - HK | Hong Kong | 116 | 288 |
| Fouquet's | Paris | 115 | 180 |
| Sparks Steak House | New York | 115 | 407 |
| Mandarin Bar and Grill | Hong Kong | 115 | 246 |
| Tin Lung Heen | Hong Kong | 113 | 182 |
| Daniel | New York | 112 | 277 |
| Man Wah | Hong Kong | 107 | 221 |
| Eleven Madison Park | New York | 107 | 174 |
| Morrell Wine Bar & Cafe | New York | 104 | 144 |
| City Winery | New York | 103 | 151 |
| Shang Palace - HK | Hong Kong | 102 | 356 |
| Porter House | New York | 101 | 147 |
| Jean Georges | New York | 101 | 136 |
| Veritas | New York | 98 | 255 |
| Asiate | New York | 96 | 191 |
| Jean-Francois Piege | Paris | 95 | 95 |
| Le Cirque | New York | 91 | 129 |
| Mathieu Pacaud - Histoires | Paris | 91 | 91 |
| Pierre Gagnaire | Paris | 91 | 129 |
| Conrad Hotel (Golden Leaf) | Hong Kong | 91 | 152 |
| Hexagone | Paris | 90 | 90 |
| Caprice | Hong Kong | 89 | 284 |
| The Mark Restaurant by Jean-Georges | New York | 88 | 134 |
| Benoit - Paris | Paris | 88 | 114 |
| Cafe Boulud New York | New York | 83 | 131 |
| G Bar | Hong Kong | 83 | 178 |
| Le Gabriel - Paris | Paris | 81 | 81 |
| Harlan's | Hong Kong | 81 | 160 |
| Le Bernardin | New York | 81 | 111 |
| Gordon Ramsay Au Trianon | Paris | 81 | 81 |
| Sevva | Hong Kong | 81 | 81 |
| Pur' | Paris | 80 | 121 |
| Guy Savoy | Paris | 79 | 79 |
| Chez Flottes | Paris | 79 | 153 |
| Tosca - HK | Hong Kong | 79 | 143 |
| L'Altro - HK | Hong Kong | 79 | 168 |
| Bouley | New York | 78 | 105 |
| Picholine | New York | 77 | 99 |
| A Voce - Columbus | New York | 77 | 181 |
| Hotel Park Hyatt- Paris Vendome | Paris | 76 | 101 |
| Angelini | Hong Kong | 76 | 76 |
| Nice Matin | New York | 76 | 181 |
| Lili au Peninsula | Paris | 73 | 115 |
| Ming Court | Hong Kong | 73 | 218 |
| La Compagine des Vins surnaturels | Paris | 73 | 83 |
| Fook Lam Moon - Hong Kong | Hong Kong | 73 | 141 |
| Drouant | Paris | 72 | 90 |
| Bibo | Hong Kong | 71 | 71 |
| Blt Prime - NYC | New York | 71 | 121 |
| La Table du Lancaster | Paris | 70 | 127 |
| Le Violon d'Ingres | Paris | 70 | 91 |
| NOBU Intercontinental Hong Kong | Hong Kong | 70 | 171 |
| Gabriel Kreuther | New York | 69 | 69 |
| Michel Rostang | Paris | 68 | 68 |
| L'Atelier de Joel Robuchon - Paris | Paris | 68 | 99 |
| Cuisine Cuisine at Mira | Hong Kong | 68 | 135 |
| Smith & Wollensky New York | New York | 68 | 96 |
| Mandarin Oriental (Krug Room) | Hong Kong | 68 | 101 |
| Cuisine Cuisine at IFC | Hong Kong | 68 | 75 |
| Le Beef Club/Fish Club | Paris | 67 | 84 |
| La Grande Cascade | Paris | 67 | 67 |
| Nicholini's | Hong Kong | 67 | 70 |
| Dominique Bouchet | Paris | 66 | 93 |
| Gotham Bar and Grill | New York | 64 | 100 |
| Benoit - New York | New York | 64 | 86 |
| Lung King Heen | Hong Kong | 64 | 163 |
| Les 110 de Taillevent | Paris | 63 | 118 |
| Rouge Tomate | New York | 63 | 120 |
| Harrys Cafe and Steak | New York | 63 | 128 |
| Le Celadon | Paris | 63 | 108 |
| La Scene - Hotel Prince de Galles— | Paris | 62 | 62 |

As prices are likely to be correlated across observations of the same wine, all errors are clustered at the wine/vintage level.

The results (see Table 9) show that the estimated quality is a significant predictor of prices. Its coefficient is positive and always significant at the 1 percent level (in four estimations, including our preferred one, it is significant at the 0.001 level); noting that a number of fixed effects have been included such as vintage×appellation, official ranking, price year and store fixed effects; and even given other controls.

In the regression of column 5, the estimated quality is the only one which significantly explains the price. Interestingly, Robert Parker who is often considered as a “guru” ends up having no significant influence on prices after controlling for estimated quality. Only Jancis Robinson's ratings are positive and significant at the 5 percent level.

As prices and ratings are in logs, the coefficients can be interpreted as elasticities. In the regression of column 5, the elasticity of the estimated quality on prices is very high: a 10 percent increase in quality raises the price of 14 percent so there is an elasticity of 1.4 of price on our quality rating.

Even when the average rating is introduced on the top of the best rating and the other salient experts' ratings (column 6), the significance of the quality estimate remains significant while the average rating is not. Thus, our rating provides significant predictions and ones that are not captured in the average rating. Note that this is even though the average rating is already incorporating an adjustment in which all experts' ratings are put on the same scale. So, it is the adjustments for accuracy and bias that are what are providing the predictive power.

TABLE 9
Retail prices as a function of estimated wine quality
and salient and best en primeur ratings.

| | (1) | (2) | (3) | (4) | (5) | (6) |
|---|---|---|---|---|---|---|
| Estimated quality | 0.736⁺ | 0.451* | 0.676⁺ | 1.235⁺ | 1.426⁺ | 1.028* |
| | (8.39) | (3.08) | (4.13) | (16.66) | (9.30) | (2.60) |
| Best rating | | 0.500⁺ | | | −0.0602 | −0.111 |
| | | (3.56) | | | (−0.43) | (−0.76) |
| R. Parker rating | | | 0.207^{#} | | 0.0286 | 0.0514 |
| | | | (2.13) | | (0.45) | (0.77) |
| J. Robinson rating | | | | 0.0953⁺ | 0.0689^{#} | 0.0587 |
| | | | | (3.43) | (2.16) | (1.77) |
| Average rating | | | | | | 0.427 |
| | | | | | | (1.13) |
| N | 39678 | 39666 | 34069 | 24468 | 21145 | 21145 |
| r2 | 0.785 | 0.790 | 0.777 | 0.824 | 0.828 | 0.828 |
| aic | 54779.4 | 53850.3 | 471143.5 | 27585.1 | 23372.5 | 23355.2 |
| bic | 56926.5 | 55997.4 | 48948.8 | 29084.5 | 24709.6 | 24700.3 |

Notes:
t-statistics are in parentheses.
The standard errors are clustered at the winex vintage level.
Significance levels: ^{#}p <0.05, *p <0.011, ⁺p <0.001, All variables (dependent and explaining) are in logs so that coefficients can be interpreted as elasticities.
All regressions include vintage × appellation, official ranking, price, year, and store fixed effects.
Ratings are corrected to span the 1-100 scale (see Equation 16).

Estimated wine qualities are correlated with retail prices, controlling for many things (including ratings). This is reassuring as it tends to confirm that prices do reflect item quality as captured by this exemplary technique. To what extent do individual expert's ratings correlate with prices as a function of how accurate they are.

It is expected that, more accurate experts are to have a greater correlation of their ratings with the prices, since their ratings correlate more strongly with the estimated true quality which correlates with prices. However, there are many other factors which may affect the correlation of prices with the ratings. To control for that log prices on each expert's logs ratings were separately regressed (see raw results in the Table 10). It is noted that several experts, such as Beck, Galloni, Lee, Leve, Perrin and Suckling, could not be considered as too few of their ratings were for wines with observed prices. Among the thirteen remaining experts, the most accurate expert, JM Quarin is also the one whose ratings correlate most with the prices: a 10 percent increase in his ratings corresponds to a 7.1 percent increase in prices. Parker, who is the second most accurate in this list has the second highest correlation between ratings and prices (a 10 percent increase in his ratings corresponds to a 6.8 percent increase in prices).

TABLE 10
Retail prices as a function of “en primeur” ratings by the
top-5 most influential experts (on p rices). A ll markets.

| | (1) | (2) | (3) | (4) |
|---|---|---|---|---|
| JM Quarin | 0.599⁺ | 0.534⁺ | 0.550⁺ | 0.517⁺ |
| | (8.91) | (7.84) | (5.83) | (5.58) |
| Robert Parker | 0.416⁺ | 0.335⁺ | 0.453⁺ | 0.447⁺ |
| | (5.22) | (4.20) | (4.29) | (3.93) |
| Rene Gabriel | | 0.328⁺ | 0.279⁺ | 0.271⁺ |
| | | (5.79) | (3.93) | (3.58) |
| Wine Enthusiast | | | 0.421⁺ | 0.417⁺ |
| | | | (7.40) | (7.02) |
| Bettane & Desseauve | | | | 0.171^{#} |
| | | | | (2.41) |
| N | 16369 | 15942 | 9849 | 9513 |
| r2 | 0.791 | 0.796 | 0.846 | 0.849 |
| aic | 20071.6 | 19133.2 | 10201.1 | 9739.1 |
| bic | 21057.6 | 20100.5 | 10935.1 | 10455.1 |

Notes:
t-statistics are in parentheses. The standard errors are clustered at the wine × vintage level. Significance levels: ^{#}p < 0.05, *p < 0.01, ⁺p < 0 .001. All regressions include vintage, re-rating year, vintage × appellation and official ranking. Ratings are corrected to span the 1-100 scale (see Equation 16). Prices and ratings are in log so that coefficients can be interpreted as elasticities. Only the experts who have rated wines for which we have a sufficient number of prices (>2000) are considered here.

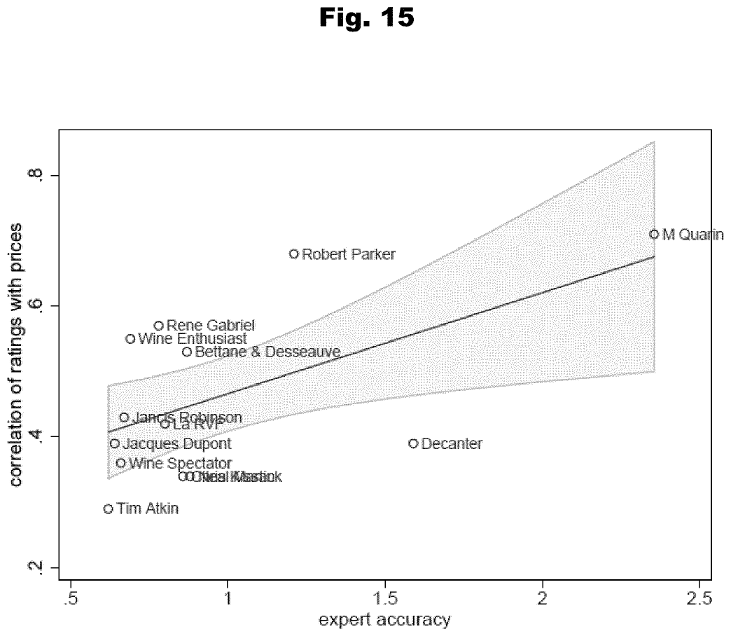

FIG. 15 shows that the correlation between an expert's ratings and prices increases with the expert's accuracy. In addition, some experts lie above or below the line. They have a residual correlation with price that goes beyond what is predicted by their accuracy (which correlates with prices because of the strength of their ratings' correlation with quality). This residual correlation could reflect different things. Here are two possibilities. It could be that the expert's rating influences the price, as is often claimed, for instance, about Parker's ratings. It could also be that the expert's rating is affected by the anticipated price point that a wine will sell at—giving higher ratings to more expensive wines (after adjusting for quality).

TABLE 11
Retail prices as a function of “en primeur” ratings by the
top-5 most influential e xperts (on p rices). P aris market.

| | (1) | (2) | (3) | (4) |
|---|---|---|---|---|
| JM Quarin | 0.588⁺ | 0.543⁺ | 0.486⁺ | 0.471⁺ |
| | (8.64) | (7.97) | (5.69) | (5.49) |
| Robert Parker | 0.282⁺ | 0.211* | 0.400⁺ | 0.412⁺ |
| | (4.11) | (3.16) | (3.84) | (3.72) |
| Rene Gabriel | | 0.313⁺ | 0.240* | 0.218* |
| | | (6.14) | (3.28) | (2.79) |
| Wine Enthusiast | | | 0.384⁺ | 0.391⁺ |
| | | | (6.23) | (6.20) |
| Bettane & Desseauve | | | | 0.153^{#} |
| | | | | (2.33) |
| N | 7438 | 7189 | 4248 | 4040 |
| r2 | 0.808 | 0.813 | 0.859 | 0.863 |
| aic | 8439.4 | 8012.2 | 4253.5 | 3971.1 |
| bic | 9296.8 | 8851.6 | 4895.3 | 4595.2 |

Notes:
t-statistics are in parentheses. The standard errors are clustered at the wine × vintage level. Significance levels: ^{#}p < 0.05, *p < 0.01, ⁺p < 0.001. All regressions include vintage, re-rating year, vintage × appellation and official ranking. Ratings are corrected to span the 1-100 scale (see Equation 16). Prices and ratings are in log so that coefficients can be interpreted as elasticities. Only the experts who have rated wines for which we have a sufficient number of prices (>2000) are considered here.

TABLE 12
Retail prices as a function of “en primeur” ratings by the
top-5 most influential experts (on prices). New York market.

| | (1) | (2) | (3) | (4) |
|---|---|---|---|---|
| JM Quarin | 0.479⁺ | 0.406⁺ | 0.531⁺ | 0.498⁺ |
| | (7.59) | (6.53) | (6.27) | (5.97) |
| Robert Parker | 0.664⁺ | 0.560⁺ | 0.492⁺ | 0.460⁺ |
| | (7.45) | (5.86) | (4.40) | (3.95) |
| Rene Gabriel | | 0.322⁺ | 0.301⁺ | 0.289⁺ |
| | | (5.07) | (4.03) | (3.72) |
| Wine Enthusiast | | | 0.370⁺ | 0.366⁺ |
| | | | (6.20) | (5.91) |
| Bettane & Desseauve | | | | 0.157 |
| | | | | (1.83) |
| N | 4247 | 4145 | 2765 | 2701 |
| r2 | 0.832 | 0.839 | 0.871 | 0.873 |
| aic | 3948.8 | 3662.5 | 2113.2 | 2042.2 |
| bic | 4590.6 | 4301.8 | 2599.0 | 2526.1 |

Notes:
t-statistics are in parentheses. The standard errors are clustered at the wine × vintage level. Significance levels: ^{#}p < 0.05, *p < 0.01, ⁺p < 0.001. All regressions include vintage, re-rating year, vintage × appellation and official ranking. Ratings are corrected to span the 1-100 scale (see Equation 16). Prices and ratings are in log so that coefficients can be interpreted as elasticities. Only the experts who have rated wines for which we have a sufficient number of prices (>2000) are considered here.

TABLE 13
Retail prices as a function of “en primeur” ratings by the
top-5 most influential experts (on prices). Hong Kong market.

| | (1) | (2) | (3) | (4) |
|---|---|---|---|---|
| JM Quarin | 0.691⁺ | 0.606⁺ | 0.626⁺ | 0.587⁺ |
| | (6.97) | (5.72) | (4.17) | (4.03) |
| Robert Parker | 0.625⁺ | 0.568⁺ | 0.613* | 0.555* |
| | (4.70) | (4.04) | (3.25) | (2.74) |
| Rene Gabriel | | 0.312⁺ | 0.290* | 0.305* |
| | | (3.32) | (2.67) | (2.75) |
| Wine Enthusiast | | | 0.521⁺ | 0.513⁺ |
| | | | (6.26) | (5.76) |
| Bettane & Desseauve | | | | 0.195 |
| | | | | (1.88) |
| N | 4684 | 4608 | 2836 | 2772 |
| r2 | 0.770 | 0.774 | 0.842 | 0.844 |
| aic | 6538.5 | 6361.5 | 3092.3 | 3015.0 |
| bic | 7170.7 | 6992.2 | 3556.4 | 3471.5 |

Notes:
t-statistics are in parentheses. The standard errors are clustered at the wine × vintage level. Significance levels: ^{#}p < 0.05, *p < 0.01, ⁺p < 0.001. All regressions include vintage, re-rating year, vintage × appellation and official ranking. Ratings are corrected to span the 1-100 scale (see Equation 16). Prices and ratings are in log so that coefficients can be interpreted as elasticities. Only the experts who have rated wines for which we have a sufficient number of prices (>2000) are considered here.

### Example 3: Experts' Biases and Accuracies that Vary with Categories of Items

Any reviewer's ability and judgment in rating items might vary with categories of items. There is no reason to expect that an expert who is extremely accurate in reviewing wines would be a good analyst for recommending movies or cars or stocks. In one scenario, it might be that, an expert on wines is much better at judging red wines than white wines, or judging Bordeaux wines than Spanish wines. The distinctions do not end there: even within Bordeaux there are distinctly different red wines. The wines from the “left bank” (the west side of the Gironde Estuary) and the “right bank” (the east side), generally contain different blends of grapes and come from different soils and can even have different weather conditions. The left bank wines are blends that predominately feature Cabernet Sauvignon grapes, while the right bank wines tend to feature Merlot grapes, with varying mixtures and often including Cabernet. Franc and other grapes. While not as different as red from white, there are still sufficient distinctions that make these two categories different from each other and it can be that a given expert would favor Cabernet Sauvignon over Merlot grapes, or vice versa. This might result in different biases and/or accuracies for the two regions.

Effectively any given expert can be treated as two completely different experts, one for Left Bank Bordeaux and one for Right Bank Bordeaux. One of those two experts might have a large positive bias and the other a slight negative bias, and correspondingly one might be very accurate and the other more variable.

One could interpret the biases as “preferences”: a deviation from the average “true” quality that favors or goes against a certain type of wine.

Thus, for any given set of items N, one can partition that set, and treat each distinct group as a completely different set of items and run the method separately on that set of items. Thus, for every reviewer, a different bias and accuracy are determined for every category of items.

To illustrate this, the data on Bordeaux wines Left Bank and Right Bank wines was split and analyzed.

Let L denote “Left Bank” and N\L denote “Right Bank”.

### Left vs Right Bank Tastes of Experts

The estimation was ran for all experts separately on the left and the right bank. Formally, the evaluations of any expert j are:

gᵢⱼ=qᵢ+b_{j,L}+ε_{i,j,L}, if i∈L (17)

gᵢⱼ=qᵢ+b_{j,N\L}+ε_{i,j,N\L}, if i∈N\L. (18)

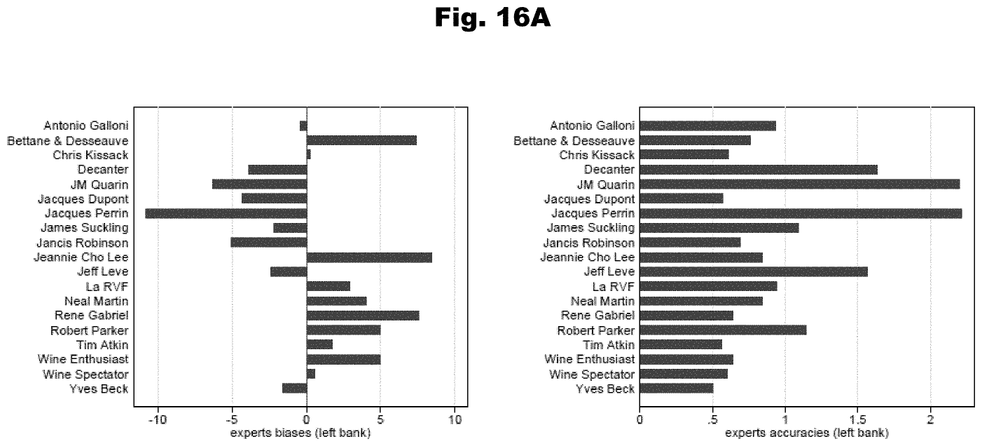

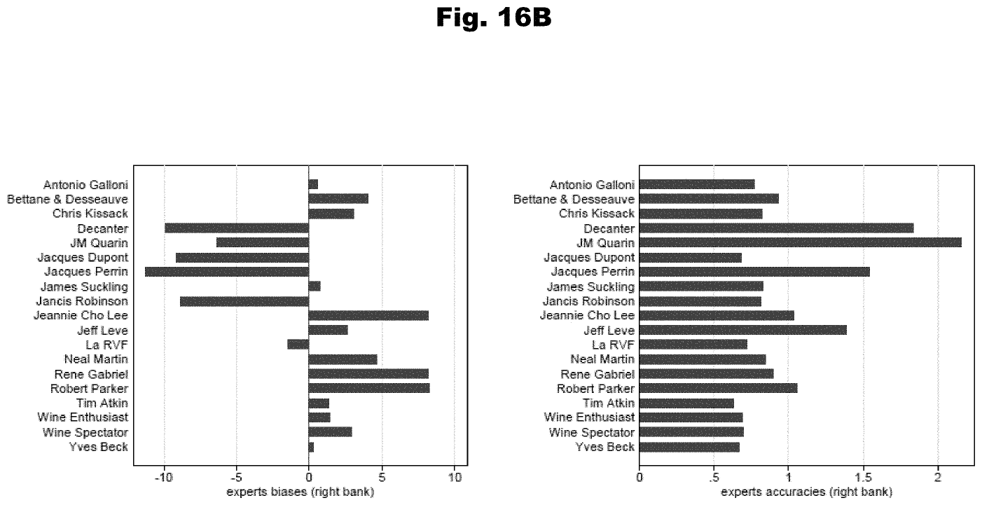

This leads to the following results (FIGS. 16A 16B).

The differences of estimated biases across the left vs right dichotomy can be computed:

Δ\hat{b}ⱼ=\hat{b}_{j,L}−\hat{b}_{j,N\L}. (19)

The differences in accuracies can also be computed:

Let

$${\hat{A}}_{j , L} = ( \frac{1}{{\hat{σ}}_{j , L}^{2}} ) ( \frac{{\sum }_{{j}^{′}} {\hat{σ}}_{{j}^{′} , L}^{2}}{{m}_{L}} )$$

denote the normalized accuracy of expert j on the Left Bank wines, and similarly define the Right Bank accuracies Â_{j,N/L}. The difference in expert j's normalized accuracies between Left Bank and Right Bank is then:

ΔÂⱼ=Â_{j,L}−Â_{j,N\L}. (20)

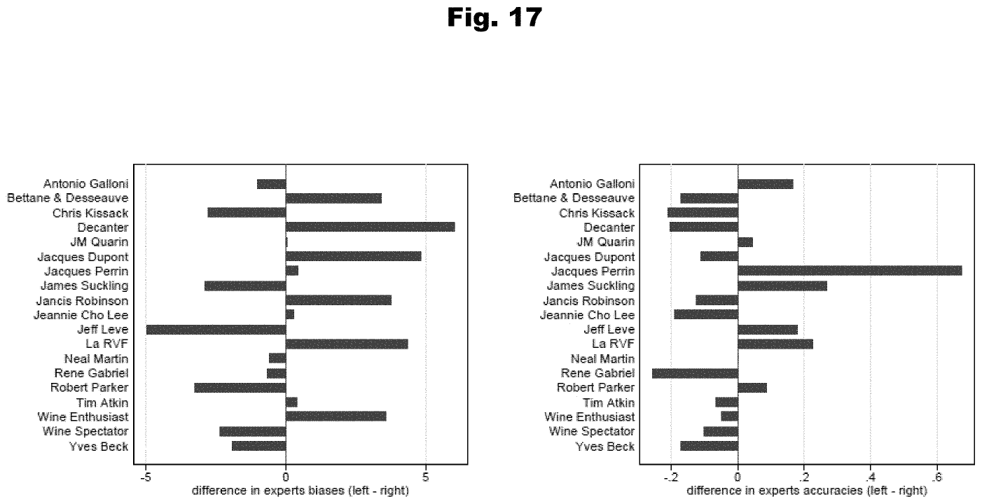

Results are provided in FIG. 17.

One can see that Robert Parker a “rightist,” which is consistent with him being known for advocating in favor of powerful Bordeaux wines, mostly located on the right bank. Other pronounced “rightists” include Jeff Leve, James Suckling, Chris Kissack, Wine Spectator and Yves Beck. On the other side, Decanter, Jacques Dupont, La RVF, Jancis Robinson, Wine Enthusiast, and Bettane & Desseauve favor more traditional and reserved wines. This could explain the lack of correlation between Parker's and Robinson's ratings which is presumed to be due to different preferences in wine “styles”.

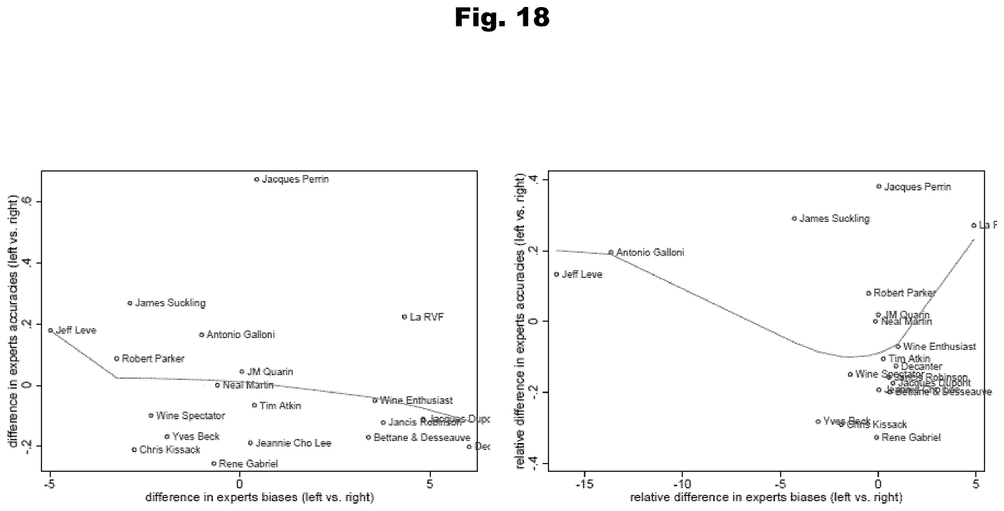

It is also interesting to explore how the differences in accuracies relate to the differences in biases. This relationship is portrayed in FIG. 18.

### A Significant Difference

Utilizing methods described herein, one can test whether there is a significant difference in Left Bank and Right Bank wines by examining whether there is a significant increase in the predictions of qualities.

First, the residual weighted sum of squares is defined for the different ways of estimating.

Without any distinction between Left and Right Bank wines, the overall weighted sum of squared errors from keeping all the wines in one category was:

RSS₁=Σ_{i,j}1ᵢⱼ(gᵢⱼ−\hat{b}ⱼ−\hat{q}ᵢ)²Âⱼ. (21)

The adjustment by

$${\hat{A}}_{j} = ( \frac{1}{{\hat{σ}}_{j}^{2}} ) ( \frac{{\sum }_{{j}^{′}} {\hat{σ}}_{{j}^{′}}^{2}}{m} )$$

weights the terms so that the errors are all normalized to have the average variance an thus the same distribution—which is the same as weighting each estimate by its relative precision which produces the overall estimated sum of squared errors. Since

Σ_{i,j}1ᵢⱼ(gᵢⱼ−\hat{b}ⱼ−\hat{q}ᵢ)²/\hat{σ}ⱼ=n

this becomes

$${RSS}_{1} = \frac{n}{m} {\sum }_{{j}^{′}} {\hat{σ}}_{{j}^{′}}^{2} \qquad ( 22 )$$

Once divided into two categories, a second sum of squared errors is calculated:

RSS₂=Σ_{i∈L,j}1ᵢⱼ(gᵢⱼ−\hat{b}_{j,L}−\hat{q}ᵢ)²Â_{j,L}+Σ_{i∈N\L,j}1ᵢⱼ(gᵢⱼ−\hat{b}_{j,N\L}−\hat{q}ᵢ)²Â_{j,N\L}

Using the similar calculations as for Equation 22, it, comes:

$${RSS}_{2} = \frac{{n}_{L}}{m} {\sum }_{{j}^{′}} {\hat{σ}}_{{j}^{′ , L}}^{2} + \frac{{n}_{N \backslash L}}{m} {\sum }_{{j}^{′}} {\hat{σ}}_{{j}^{′} , N \backslash L}^{2} , \qquad ( 23 )$$

noting that all experts are rating wines on both Left and Right. Banks, and so there is no subscripting on n.

The results identify n=36,821 ratings of red wines into one of the Left or the Right bank (some wines blend grapes from both sides of the river and the origins of some others is not clear in the data). These divide into n_{L}=19,560 ratings of Left Bank wines and n_{N/L}=17,261 of Right. Bank wines. Then, with the data, it is determined that

$${RSS}_{1} = \frac{36 , 821}{19} \times 2 , 699.726 = 5 , 231 , 926 , and$$

$${RSS}_{2} = \frac{19 , 560}{19} \times 2 , 473.073 + \frac{17 , 261}{19} \times 2 , 854.266 = 5 , 138 , 989.5 .$$

There are 38 parameters estimated in the original algorithm and 76 parameters estimated in the algorithm in which wines were split into Left and Right Banks. This results in an F-test statistic of:

$$F = \frac{( \frac{{RSS}_{1} - {RSS}_{2}}{76 - 38} )}{( \frac{{RSS}_{2}}{36 , 821 - 76 - 1} )} = \frac{( \frac{92 , 936.5}{38} )}{( \frac{5 , 138 , 989.5}{36 , 744} )} = 17.487 \qquad ( 24 )$$

At a 1 percent significance level, the F-test threshold with (38; 36,744) degrees of freedom is 1.59. The F statistic of 17.487 greatly exceeds that threshold value. Thus, there are significant differences in experts' rating patterns for Left and Right Bank wines.

### Example 4: Possible Micro-Foundations for the Empirics

In this example, a couple of simple models that would micro-found the reduced form regressions on prices are presented. As such, these models introduce specific assumptions that are not necessary, but provide one possible rational.

### Prices

A wine has an unobserved quality q that is a function of some fundamentals f and of an independent term ϕ:

q=f+ϕ. (25)

An expert observes the fundamentals and a noisy signal of the other term: s^{r}=ϕ+∈^{r} with ∈^{r}˜Φ(0, σ^{r}). The expert rates the item as

g^{r}=E(q|s^{r},f)=f+E(ϕ|s)=f+s^{r}, (26)

with E (q|s^{r}, f) denoting the expected quality conditioned on the observed s^{r} and f. This would be a typical “en primeur” rating of a Bordeaux wine, which most of the time isn't blind. Note that the bias is not considered here to keep the notation uncluttered, but introducing it would be straightforward (just add it into the rating above).

Consumers are unbiased and can also observe the fundamentals. If the consumers aggregate a set of noisy and independent signals s∈S that provide information about the term ϕ, then one can capture their expectation as E(q|f,S).

Regardless of how many ratings a consumer observes, because of the salience of some particular expert's rating, the consumer could also directly be influenced by that rating. The consumer may also be influenced by other factors such as the information printed on the bottle, e.g. the brand, the appellation and the official ranking. A simple way of thinking of this problem is to mix these factors, so that with some weight or probability λ the consumers base their expectation on a set of observed reviews S, with weight or probability μ they follow the signal on quality contained in the public information (the brand, appellation or official ranking) a, and with the remaining weight or probability (1−λ−μ), they follow the salient expert's rating. The conditional expected quality or random consumer is then given by

$$E ( q \text{\textbar} g , f , S ) = λ E ( q \text{\textbar} f , S ) + μ a + ( 1 - λ - μ ) ( E ( q \text{\textbar} {s}^{r} , f ) ) = λ \hat{q} + μ a + ( 1 - λ - μ ) {g}^{r} + ɛ \qquad ( 27 )$$

where \hat{q} is the best estimate of q given S (e.g., as the one we developed here), and a is an error term.

In the Bordeaux wine industry, quantities are completely fixed for a given vintage (production cannot be significantly adjusted upward by mixing the wine of that vintage with wine from other vintages). The main adjustment to increased demand is via prices. We therefore estimate an hedonic (price) regression of the form: g_{θ}(p)=E(q|g^{r}, f,S,b^{r}), where g_{θ}⁻¹ (·) is an increasing function that gives a price to a “perceived” quality in the market. For example:

p=β\hat{q}+β^{r}g^{r}+vₐ+v_{f}+vₜ+vₛₜₒ, (28)

where g_{θ}(·) is assumed to be linear with slope θ, and with β=λθ, β^{r}=(1−λ−μ)θ. The other terms of the right hand side of Equation (28) control for effects found in the literature so far. The term vₐ denotes the official ranking fixed effect. A fundamentals fixed effect v_{f} is added because it is likely that the fundamentals are not perfectly observed by the expert and could influence the price. The two other fixed effects, vₜ and vₛₜₒ, capture the selling year and the retail store specifies that may also affect the posted price.

The coefficients β and β^{r} are parameters of interest. It is conjectured that the measure of true quality impacts prices, and so even when controlling for all determinants including for some salient experts ratings, β should remain positive and significant. Some of the previous literature suggests coefficient β^{r} may also be positive and significant.

### Re-Ratings

Next, consider a situation in which an expert, who already rated a wine/vintage “en primeur”, re-rates that same wine. The expert observes two signals, s in the first period (en primeur), as well as a new conditionally independent signal s′, so that s=ϕ+∈ and s′=ϕ+∈′ with ∈,∈′˜Φ(0,σ) and ∈′⊥∈. In the first period, every thing works as before, that is as in Equation 26 (dropping r superscripts). In the second period, the expert's rating is may be dependent, upon her own previous signal. Moreover, the expert could be also influenced by peers, and in particular by the most prominent ones. Therefore the expert's re-estimation of quality is E(q|s,s′,s^{r}, f), which is conditioned on the fundamentals f, the previous signal s, the new signal s′, and the “reference expert” rating g^{r} (which, for instance, leads the expert to know the other prominent expert's signal s^{r}). The new rating g′ is thus given by:

g′=E(q|s,s′,s^{r},f)=f+E(ϕ|s,s′,s^{r}). (29)

Again, as a simplifying assumption, suppose that the expert weights the first signal with prob λ, the new signal with prob μ, and the reference expert signal with prob (1−λ−μ). Equation (29) becomes

g′=f+λE(ϕ|s)+μE(ϕ|s′)+(1−λ−μ)E(ϕ|s^{r}).

Using Equations 25 and 26, this becomes:

g′=f+λg+μ(\hat{q}−f+∈′)+(1−λ−μ)g^{r}.

Rearranging:

g′=β₁\hat{q}+β₂g+β₃g^{r}+∈′+vₐ+v_{f}+vₜ+vₑ, (30)

where β₁=μ, β₂=λ and β₃=(1−λ−μ). As before, vₐ denotes official ranking fixed effects and v_{f} a vintage/appellation fixed effect that captures the fundamentals. The term vₜ accounts for the re-rating year and vₑ is an expert fixed effect. The error term ∈′ is an error term.

What is claimed is:

1. A method for determining a final quality of a ratable item using a computer system, comprising:
receiving, using a computer system, a compilation of ratings of a set of items, wherein each item has a rating provided by a set of raters, where:
the set of items is at least two items;
the set of raters is at least two raters; and
a first rater and a second rater, of the set of raters, have each provided a rating of a first item and a second item, of the set of items;
determining, using the computer system, an initial estimate of an error and a bias of each rater in the set of raters;
determining, using the computer system, an initial estimate of a quality of each item in the set of items;
centering, using the computer system, the estimate of the quality of each item, of the set of items, at a current estimate of the mean quality of all items in the set of items;
solving the estimates of the quality of each item, the error of each rater, and the bias of each rater, of the set of raters;
iteratively repeating, using the computer system:
the centering of the estimate of the quality each item, of the set of items, at a current estimate of the mean quality of all items in the set of items; and
the solving of the estimates of the quality of each item, the error of each rater, and the bias of each rater;
until the estimates converge into a solution that provides a final quality of each item in the set of items, a final accuracy of each rater of the set of raters, and a final bias of each rater of the set of raters.

2. The method of claim 1, wherein the quality of each rated item is solved at each iteration with a formula:
$${Q}_{i}^{t + 1} = \frac{{\sum }_{j} \frac{{1}_{ij} ( {g}_{ij} - {b}_{j}^{t + 1} )}{{( {σ}_{j}^{t + 1} )}^{2}}}{{\sum }_{j} \frac{{1}_{ij}}{{( {σ}_{j}^{t + 1} )}^{2}}} \\ {q}_{i}^{t} = {Q}_{i}^{t} + {\tilde{q}}^{t} - \frac{{\sum }_{{i}^{′}} {Q}_{{i}^{′}}^{t}}{n} )$$
wherein qᵢ^{t} is the quality q of an item i at iteration t, gᵢⱼ is the rating of item i by a rater j, bⱼ^{t} is the bias b of a rater j at iteration t, (σⱼ^{t+1})² is the error σ₁² of a rater j at iteration t, and Qᵢ^{t} is the overall mean quality in iteration t.

3. The method of claim 1, wherein the error of each rater is solved at each iteration with a formula:
$${( {σ}_{j}^{t + 1} )}^{2} = {\sum }_{i} \frac{{1}_{ij} {( {g}_{ij} - {b}_{j}^{t} - {q}_{i}^{t} )}^{2}}{{n}_{j}}$$
wherein (σⱼ^{t+1})² is the error σ₁² of a rater j at iteration t, gᵢⱼ is the rating of item i by a rater j, qᵢ^{t} is the quality q of an item i at iteration t, bⱼ^{t} is the bias b of a rater j at iteration t, and nⱼ is the total number n of raters j.

4. The method of claim 1, wherein the bias of each rater is solved at each iteration with a formula:
$${b}_{j}^{t + 1} = {\sum }_{i} \frac{{1}_{ij} ( {g}_{ij} - {q}_{i}^{t} )}{{n}_{j}} , \text{∀} j$$
wherein bⱼ^{t} is the bias b of a rater j at iteration t, gᵢⱼ is the rating of item i by a rater j, qᵢ^{t} is the quality q of an item i at iteration t, and nⱼ is the total number n of raters j.

5. The method of claim 1, wherein the estimates of each item's quality are centered at a current estimate of the mean quality of all items with an equation:
$${\tilde{q}}^{t} = {\sum }_{i} \frac{1}{n} ( \frac{{\sum }_{j} \frac{{1}_{ij} {g}_{ij}}{{( {σ}_{j}^{t} )}^{2}}}{{\sum }_{j} \frac{{1}_{ij}}{{( {σ}_{j}^{t} )}^{2}}} )$$
wherein gᵢⱼ is the rating of item i by a rater j, n is the total number of items i, nⱼ is the total number of raters j, mᵢ is the number ratings for each item i, and \tilde{q}^{t} is the best current estimate of the overall average true quality through iteration t.

6. The method of claim 1, wherein the initial estimate of each rater's error is an arbitrary positive number.

7. The method of claim 1, wherein the initial estimate of each rater's bias bⱼ⁰ is calculated using a formula:
$${b}_{j}^{0} = {\sum }_{i} \frac{{1}_{ij}}{{n}_{j}} ( {g}_{ij} - {\sum }_{k \neq j} \frac{{1}_{ik} {g}_{ik}}{{m}_{i} - 1} ) , \text{∀} j$$
wherein gᵢⱼ is the rating of item i by a rater j, n is the total number of items i, nⱼ is the total number of raters j, and mᵢ is the number ratings for each item i.

8. The method of claim 1, wherein the initial estimate of each item's quality qᵢ⁰ is calculated using formulas:
$${Q}_{i}^{0} = \frac{{\sum }_{j} \frac{{1}_{ij} ( {g}_{ij} - {b}_{j}^{0} )}{{( {σ}_{j}^{0} )}^{2}}}{{\sum }_{j} \frac{{1}_{ij}}{{( {σ}_{j}^{0} )}^{2}}} \\ and \\ {q}_{i}^{0} = {Q}_{i}^{0} + {\tilde{q}}^{0} - \frac{{\sum }_{{i}^{′}} {Q}_{{i}^{′}}^{0}}{n} )$$
wherein gᵢⱼ is the rating of item i by a rater j, n is the total number of items i, nⱼ is the total number of raters j, mᵢ is the number ratings for each item i, and Qᵢ⁰ is the overall mean quality in iteration t.

9. The method of claim 1 further comprising pricing the first item based upon the final quality of the first item.

10. The method of claim 1 further comprising displaying the first and the second items in an order based upon the final qualities of the first and the second items.

11. The method of claim 10, wherein the first and the second items are displayed on an online marketplace.

12. The method of claim 1 further comprising displaying the first item when the final quality of the first item exceeds a threshold.

13. The method of claim 12, wherein the first item is displayed on an online marketplace.

14. The method of claim 1 further comprising importing the first item when the final quality of the first item exceeds a threshold.

15. The method of claim 1 further comprising setting a regulatory standard based at least upon the final quality of the first item.

16. The method of claim 1, wherein the first item is a consumer product.

17. The method of claim 16, wherein the consumer product is selected from a group consisting of: electronics, groceries, clothing, and vehicles.

18. The method of claim 16, wherein the consumer product is wine.

19. The method of claim 1, wherein the first item is a professional service.

20. The method of claim 19, wherein the professional service is selected from a group consisting of: medical services, contractor services, legal services, and brokerage services.

21. The method of claim 1, wherein the first item is an entertainment program.

22. The method of claim 21, wherein the entertainment program is selected from a group consisting of: cinema, theater, television, online streaming, music, and literature.

23. The method of claim 1, wherein the first item is an investment security.

24. The method of claim 1, wherein the first item is a food and beverage establishment.

25. The method of claim 24, wherein the food and beverage establishment is selected from a group consisting of: restaurants, bars, clubs, wineries, breweries, and catering.

26. The method of claim 1, wherein the first item is an educational service.

27. The method of claim 26, wherein the educational service is selected from a group consisting of: universities, colleges, teachers, and test preparation courses.

28. The method of claim 1, wherein the first item is a transportation and travel service.

29. The method of claim 28, wherein the transportation and travel service is selected from a group consisting of: hotels, airlines, trains, rental cars, and ridesharing.

30. The method of claim 1, wherein the first item is a game.

31. The method of claim 1, wherein the first item is a sport team.

32. The method of claim 1 further comprising:
identifying, using the computer system, a fraudulent rating within the compilation of ratings, utilizing a distribution of ratings of at least one rater of the set of raters; and
removing, using the computer system, the fraudulent rating from the compilation of ratings prior to solving the final quality of each item in the set of items, the final accuracy of each rater of the set of raters, and the final bias of each rater of the set of raters.

33. A method for correcting for errors and biases within data sets using a computer system, comprising:
receiving, using a computer system, a compilation of quality indicators of a set of items, wherein each item has been provided a quality indicator by a set of data sources, where:
the set of items is at least two items;
the set of data sources is at least two data sources; and
a first data source and a second data source, of the set of data sources, have each provided a quality indicator of a first item and a second item, of the set of items;
determining, using the computer system, an initial estimate of an error and a bias of each data source in the set of data sources;
determining, using the computer system, an initial estimate of a quality of each item in the set of items;
centering, using the computer system, the estimate of the quality of each item, of the set of items, at a current estimate of the mean quality of all items in the set of items;
solving, using the computer system, the estimates of the quality of each item, the error of each data source, and the bias of each data source, of the set of data sources;
iteratively repeating, using the computer system:
the centering of the estimate of the quality each item, of the set of items, at a current estimate of the mean quality of all items in the set of items; and
the solving of the estimates of the quality of each item, the error of each data source, and the bias of each data source;
until the estimates converge into a solution that provides a final quality of each item in the set of items, a final accuracy of each data source of the set of data sources, and a final bias of each data source of the set of data sources.

34. The method of claim 33, wherein the quality of each item is solved at each iteration with a formula:
$${Q}_{i}^{t + 1} = \frac{{\sum }_{j} \frac{{1}_{ij} ( {g}_{ij} - {b}_{j}^{t + 1} )}{{( {σ}_{j}^{t + 1} )}^{2}}}{{\sum }_{j} \frac{{1}_{ij}}{{( {σ}_{j}^{t + 1} )}^{2}}} \\ {q}_{i}^{t} = {Q}_{i}^{t} + {\tilde{q}}^{t} - \frac{{\sum }_{{i}^{′}} {Q}_{{i}^{′}}^{t}}{n} )$$
wherein qᵢ^{t} is the quality q of an item i at iteration t, gᵢⱼ is the quality indicator of item i by a data source j, bⱼ^{t} is the bias b of a data source j at iteration t, (σⱼ^{t+1})² is the error σⱼ² of a data source j at iteration t, and Qᵢ^{t} is the overall mean quality in iteration t.

35. The method of claim 33, wherein the error of each data source is solved at each iteration with a formula:
$${( {σ}_{j}^{t + 1} )}^{2} = {\sum }_{i} \frac{{1}_{ij} {( {g}_{ij} - {b}_{j}^{t} - {q}_{i}^{t} )}^{2}}{{n}_{j}}$$
wherein (σⱼ^{t+1})² is the error σⱼ² of a data source j at iteration t, gᵢⱼ is the quality indicator of item i by a data source j, qᵢ^{t} is the quality q of an item i at iteration t, bⱼ^{t} is the bias b of a data source j at iteration t, and nⱼ is the total number n of data sources j.

36. The method of claim 33, wherein the bias of each data source is solved at each iteration with a formula:
$${b}_{j}^{t + 1} = {\sum }_{i} \frac{{1}_{ij} ( {g}_{ij} - {q}_{i}^{t} )}{{n}_{j}} , \text{∀} j$$
wherein bⱼ^{t} is the bias b of a data source j at iteration t, gᵢⱼ is the quality indicator of item i by a data source j, qᵢ^{t} is the quality q of an item i at iteration t, and nⱼ is the total number n of data sources j.

37. The method of claim 33, wherein the estimates of each item's quality are centered at a current estimate of the mean quality of all items with an equation:
$${\tilde{q}}^{t} = {\sum }_{i} \frac{1}{n} ( \frac{{\sum }_{j} \frac{{1}_{ij} {g}_{ij}}{{( {σ}_{j}^{t} )}^{2}}}{{\sum }_{j} \frac{{1}_{ij}}{{( {σ}_{j}^{t} )}^{2}}} )$$
wherein gᵢⱼ is the quality indicator of item i by a data source j, n is the total number of items i, nⱼ is the total number of data sources j, mᵢ is the number quality indicators for each item i, and \tilde{q}^{t} is the best current estimate of the overall average true quality through iteration t.

38. The method of claim 33, wherein the initial estimate of each data source's error is an arbitrary positive number.

39. The method of claim 33, wherein the initial estimate of each data source's bias bⱼ⁰ is calculated using a formula:
$${b}_{j}^{0} = {\sum }_{i} \frac{{1}_{ij}}{{n}_{j}} ( {g}_{ij} - {\sum }_{k \neq j} \frac{{1}_{ik} {g}_{ik}}{{m}_{i} - 1} ) , \text{∀} j$$
wherein gᵢⱼ is the quality indicator of item i by a data source j, n is the total number of items i, nⱼ is the total number of data sources j, and mᵢ is the number quality indicators for each item i.

40. The method of claim 33, wherein the initial estimate of each item's quality qᵢ⁰ is calculated using formulas:
$${Q}_{i}^{0} = \frac{{\sum }_{j} \frac{{1}_{ij} ( {g}_{ij} - {b}_{j}^{0} )}{{( {σ}_{j}^{0} )}^{2}}}{{\sum }_{j} \frac{{1}_{ij}}{{( {σ}_{j}^{0} )}^{2}}} \\ and \\ {q}_{i}^{0} = {Q}_{i}^{0} + {\tilde{q}}^{0} - \frac{{\sum }_{{i}^{′}} {Q}_{{i}^{′}}^{0}}{n} )$$
wherein gᵢⱼ is the quality indicator of item i by a data source j, n is the total number of items i, nⱼ is the total number of data sources j, i is the number quality indicators for each item i, and Qᵢ⁰ is the overall mean quality in iteration t.

41. The method of claim 33 further comprising pricing the first item based upon the final quality of the first item.

42. The method of claim 33 further comprising displaying the first and the second items in an order based upon the final qualities of the first and the second items.

43. The method of claim 42, wherein the first and the second items are displayed on an online marketplace.

44. The method of claim 33 further comprising displaying the first item when the final quality of the first item exceeds a threshold.

45. The method of claim 44, wherein the first item is displayed on an online marketplace.

46. The method of claim 33 further comprising importing the first item when the final quality of the first item exceeds a threshold.

47. The method of claim 33 further comprising setting a regulatory standard based at least upon the final quality of the first item.

48. The method of claim 33, wherein the first item is a consumer product.

49. The method of claim 48, wherein the consumer product is selected from a group consisting of: electronics, groceries, clothing, and vehicles.

50. The method of claim 48, wherein the consumer product is wine.

51. The method of claim 33, wherein the first item is a professional service.

52. The method of claim 51, wherein the professional service is selected from a group consisting of: medical services, contractor services, legal services, and brokerage services.

53. The method of claim 33, wherein the first item is an entertainment program.

54. The method of claim 53, wherein the entertainment program is selected from a group consisting of: cinema, theater, television, online streaming, music, and literature.

55. The method of claim 33, wherein the first item is an investment security.

56. The method of claim 33, wherein the first item is a food and beverage establishment.

57. The method of claim 56, wherein the food and beverage establishment is selected from a group consisting of: restaurants, bars, clubs, wineries, breweries, and catering.

58. The method of claim 33, wherein the first item is an educational service.

59. The method of claim 58, wherein the educational service is selected from a group consisting of: universities, colleges, teachers, and test preparation courses.

60. The method of claim 33, wherein the first item is a transportation and travel service.

61. The method of claim 60, wherein the transportation and travel service is selected from a group consisting of: hotels, airlines, trains, rental cars, and ridesharing.

62. The method of claim 33, wherein the first item is a game.

63. The method of claim 33, wherein the first item is a sport team.

64. The method of claim 33 further comprising:
identifying, using the computer system, a fraudulent quality indicator within the compilation of quality indicators, utilizing a distribution of quality indicators of at least one data source of the set of data sources; and
removing, using the computer system, the fraudulent quality indicator from the compilation of quality indicators prior to solving the final quality of each item in the set of items, the final accuracy of each data source of the set of data sources, and the final bias of each data source of the set of data sources.
